(19) United States
(12) Patent Application Publication
(10) Pub. No.: US 2016/0050030 A1
(43) Pub. Date: Feb. 18, 2016

(54) SYSTEM AND METHOD FOR COMMUNICATION WITH TIME DISTORTION

(71) Applicant: THE BOARD OF TRUSTEES OF THE UNIVERSITY OF ILLINOIS, Urbana, IL (US)

(72) Inventors: Thomas Riedl, Urbana, IL (US); Andrew Singer, Champaign, IL (US)

(21) Appl. No.: 14/681,584

(22) Filed: Apr. 8, 2015

Related U.S. Application Data
(63) Continuation-in-part of application No. 13/844,543, filed on Mar. 15, 2013.
(60) Provisional application No. 61/977,699, filed on Apr. 10, 2014.
(60) Provisional application No. 61/731,406, filed on Nov. 29, 2012.

(51) Int. Cl. H04B 11/00; H04Q 9/00; G08C 23/02

(52) U.S. Cl. CPC H04B 11/00; G08C 23/02; H04Q 9/00

(57) ABSTRACT

A system and method includes a receiver configured to receive a communication signal from a transmitter. A motion determining unit connected with the receiver is configured to provide information about a motion of the receiver relative to the transmitter. An adaptive equalizer is connected with the transmitter, the adaptive equalizer is configured to use the information about the motion to undo effects of time variation in the communication signal.

### CROSS-REFERENCE TO RELATED APPLICATION

This application is a continuation-in-part of U.S. application Ser. No. 13/844,543, filed Mar. 15, 2013, which claims the benefit of U.S. Provisional Application Ser. No. 61/731,406, filed Nov. 29, 2012. This application also claims the benefit of U.S. Provisional Application Ser. No. 61/977,699, filed Apr. 10, 2014. The disclosures of all of the aforementioned applications are hereby incorporated by reference in their entirety.

### GOVERNMENT LICENSE RIGHTS

This invention was made with government support under contract numbers ONR MURI N00014-07-1-0738 and ONR MURI N00014-07-1-0311 awarded by the Office of Naval Research. The government has certain rights in the invention.

### BACKGROUND

Underwater acoustic communication is a technique of sending and receiving messages below water. There are several ways of employing such communication but the most common is using acoustic transducers and hydrophones. Under water communication is difficult due to factors like multi-path propagation, time variations of the channel, small available bandwidth and strong signal attenuation, especially over long ranges. In underwater communication there can be low data rates compared to terrestrial communication.

### BRIEF DESCRIPTION OF THE DRAWINGS

In association with the following detailed description, reference is made to the accompanying drawings, where like numerals in different figures can refer to the same element.

FIG. 1 is a graph of an example attenuation of an electromagnetic (EM) plane wave in seawater for frequencies up to about 1016 HZ.

FIG. 2 is a graph of an example attenuation of an electromagnetic plane wave versus an acoustic plane wave in sea water.

FIG. 3 is a graph showing an example information theoretic capacity of the underwater acoustic channel for different levels of transmit power.

FIG. 4 is a graph of example information for theoretic channel capacity between two ITC-1089D transducers using 2 W of input power in sea water as a function of distance.

FIG. 5 is a diagram of a transmit array at position xᵢ with orientation θᵢ and a receive array at position xₗ with orientation θₗ.

FIG. 6 is a diagram illustrating an example of multi-path effects with each path interpreted as a line of sight path to a phantom source.

FIG. 7 is a graph of an example absorption coefficient, 10 log₁₀ a(f) in dB/m. Acoustic channel observations in reality also contains some noise.

FIG. 8 is a graph of an example power spectral density of the ambient noise, N(f), in (dB re μPa/\sqrt{Hz}).

FIG. 9 is a graph of typical self-noise referred to input of the Reson TC4014 broad band spherical hydrophone.

FIG. 10 is a graph of an example operation of the function g(\dot{x}) from Definition 3 for \dot{x}ₘₐₓ=1.

FIG. 11 is a graph of an example MACE10 Transmission Map.

FIGS. 12 (day 1), 13 (day 3) and 14 (day 4) summarize the Bit Error Rate (BER) performance of the receiver of the example MACE 2010 data set. Zero is displayed as 10⁻¹⁰ in the BER plots.

FIG. 15 is a graph of an example speed as estimated by our Doppler compensator during an example MACE10 transmission.

FIG. 16 is a graph of an example absolute value of channel impulse response as estimated during an example MACE10 transmission.

FIG. 17 is a flowchart of an example process for handling Doppler and time dispersion effects, e.g., for underwater wireless communications.

FIG. 18 is a flowchart of another example process for handling Doppler and time dispersion effects, e.g., for wireless communications such as underwater communications.

FIG. 19 is a flowchart of another example process for handling Doppler and time dispersion effects, e.g., for wireless communications such as underwater communications.

FIG. 20 is a flowchart of another example process for handling Doppler and time dispersion effects, e.g., for wireless communications such as underwater communications.

FIG. 21 is a flowchart of another example process for handling Doppler and time dispersion effects, e.g., for wireless communications such as underwater communications.

FIG. 22 is a flowchart of another example process for handling Doppler and time dispersion effects, e.g., for wireless communications such as underwater communications.

### DETAILED DESCRIPTION

Systems and methods are described herein for wireless communications, such as underwater wireless communication. Among other things, reliable underwater communication can help prevent environmental disasters, e.g., oil flow from deep water sites into the ocean. The transition from wired to wireless communication has fundamentally changed how people interact and how industries operate. This technological revolution has had little impact on communication undersea. Radio waves used to carry information wirelessly above land typically propagate poorly in seawater. As a result, wireless communication technologies such as Global Positioning Satellites (GPS), Wi-Fi or cellular communication do not work below the ocean surface. Without reliable underwater wireless communication, industries and organizations that operate underwater use underwater communication that almost entirely done through wired links, e.g., a wire or a cable connects the sender to the receiver.

Additionally, underwater operations that rely on divers can be expensive, restricted to shallow waters, and put a human life at risk. The subsea industry relies on remotely operated vehicles (ROVs) for work performed in the deep ocean. An operator on the surface communicates with the machine through a bulky cable. A massive surface ship is required to safely deploy such a vehicle and handle its heavy cable to the sea floor. Even when winds are strong and waves are high, the surface ship needs to be capable to hold its position above the vehicle. Mooring or anchoring is not practical in deep water or above dense infrastructure at the sea bottom. So the ROV support ships are outfitted with expensive dynamic positioning systems that use GPS, inertial sensor and gyro compass readings to automatically control position and heading by means of active thrust. Such ships can be extremely costly.

If, instead of a cable, a wireless carrier is used to communicate with the ROV, the heavy cables can be omitted and the expensive surface ships are no longer needed. Subsea missions can be accomplished quicker, cheaper and with fewer personnel. Wireless links could eliminate the surface vessel and associated cost. The systems and methods can provide for reliable, high-speed wireless underwater communications for remote-control of subsea machinery, e.g., on the order of Mbps instead of kbps. The systems and methods can provide desirable bandwidth, data rates, range, security, and/or reliability, etc. For example, the systems and methods can allow the collection of data from underwater sensors in real-time. The exemplary embodiments described herein incorporate by reference the features and processes described in “Communication and Time Distortion” by Thomas Riedl published by the Graduate College of the University of Illinois at Urbana-Champaign, 2014.

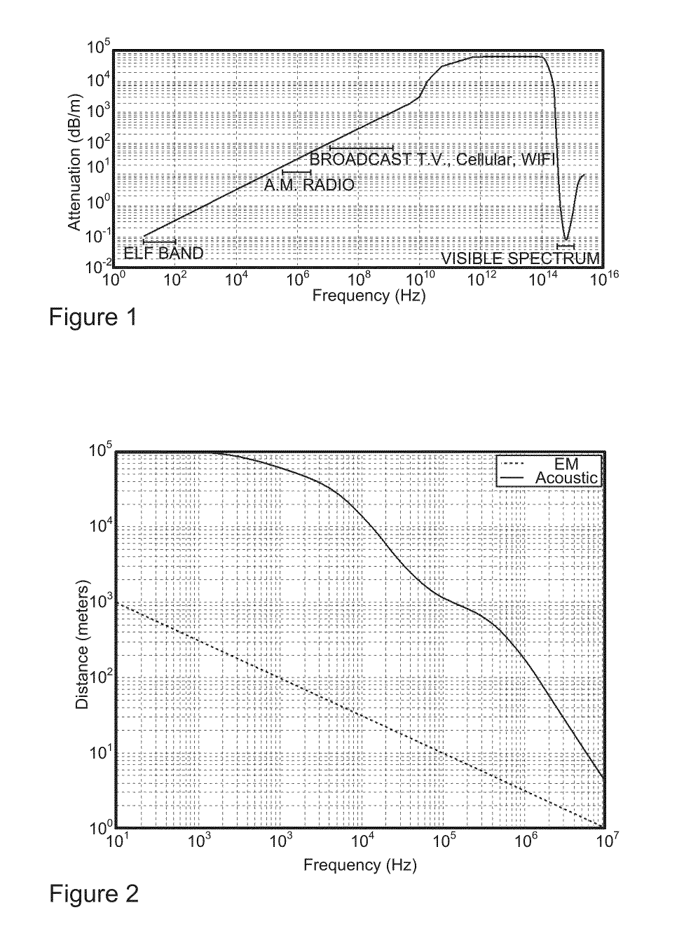

FIG. 1 is a graph of an example attenuation of an electromagnetic (EM) plane wave in seawater for frequencies up to about 10¹⁶HZ. Two types of waves that can be used to carry information wirelessly subsea include EM waves and acoustic waves. Salt water has a higher electrical conductivity than air and attenuates EM waves as they propagate. The level of attenuation depends on frequency. In FIG. 1, at frequencies below about 100 Hz and in the visible spectrum the attenuation is low enough to allow useful penetration into the water column. The attenuation is greater than 30 dB/m for all radio frequencies above 1 MHz. Inside the visible spectrum, blue-green light, around 480 nm in wave-length, propagates with the least attenuation. So-called extremely low frequency (ELF) waves are EM waves with frequencies below 100 Hz. These waves are a practical means to communicate wirelessly with a submerged vessel from land. A drawback of ELF communication is the low bandwidth available and hence a low achievable data rate of less than about 1 bps. In typical seawater, a 100 Hz EM wave is attenuated by 100 dB after 323 m and a 100 kHz EM wave is attenuated by 100 dB after 8.8 m. At a range of 50 m, data rates of about 300 bps have been reached.

Free-space optical communication underwater has received renewed interest from researchers due to recent improvement in laser and light emitting diode (LED) technology. LEDs are low-cost and power-efficient light sources and their light intensity and switching speed have been shown to accommodate wireless underwater communication at 1 Mbps over 100 m. Transmissions can be error free for ranges up to 100 m but the error rate can increase at ranges beyond 100 m. The error rate reaches 0.5 at about 140 m. This is still a step up from RF communication. Several issues, however, can limit the applicability of free-space optical communication in practice. For example, communication range is highly dependent upon water turbidity. The above values for light attenuation in water only hold for operation in pristine and transparent water. But near-shore and estuarine waters are typically highly turbid because of inorganic particles or dissolved organic matter from land drainage. Light attenuation is exponential in distance. If, for a given wavelength λ, I₀(λ) is the light intensity at the source, the light intensity I (λ, z) at distance z from the source is described by the Beer-Lambert law:

I(λ,z)=I₀ₑ^{-c(λ)z} (Equation 1)

The wavelength-dependent factor c(λ) is the extinction coefficient of the water through which the optical system operates. For the type of light best suited for optical communication, blue-green light with a wavelength of 480 nm, the extinction factor is about 0.16 m⁻¹ for pristine ocean water and about 2.8 m⁻¹ for typical coastal waters. For an extinction coefficient of 0.05 m⁻¹ for clear water, according Equation 1, the attenuation is about 21.7 dB at 100 m distance. This suggests that in typical coastal water with an extinction coefficient of about 2.8 m⁻¹, the system may only manage a range of about 1.8 m. The waters of many commercial interests, such as in the Gulf of Mexico or in the Irish Sea are highly turbid. Measurements in the Gulf of Mexico indicate that the extinction factor exceeds 3 m⁻¹ at many sites and can be as high as 5.1 m⁻¹. Turbidity is also high near underwater work and construction sites because sand and other particles are stirred up by operations. These are the spaces in which many underwater vehicles operate, and in which the need for wireless communication is great.

An issue of underwater optical communication is that different hardware is needed for the emission and reception of light—LEDs for emission and a photo-multiplier tube for reception, for example. This roughly doubles the footprint of the complete system. Further, available light emission hardware such as LEDs and lasers are highly directional and require the transmitter and receiver to be aligned with each other. This is an issue in mobile applications where the emitter needs to be constantly re-aimed as the mobile platform moves through the water. High sensitivity to water turbidity, bulkiness and tight alignment requirements are issues in free-space underwater optical communication and limit its applicability to cases where a clear line-of-sight path is available and alignment of transmitter and receiver is simple.

FIG. 2 is a graph of an example attenuation of an electromagnetic plane wave versus an acoustic plane wave in sea water. A practical method of carrying information wirelessly undersea over distances greater than a couple of meters is through acoustic wave propagation. In seawater, acoustic waves are significantly less attenuated than radio waves. FIG. 2 compares how far acoustic and radio waves can propagate through seawater until total attenuation reaches 100 dB. At a frequency of 1 MHz, radio waves are attenuated by 100 dB at only about 3 m of distance. At the same frequency, acoustic waves propagate for 200 m until this level of attenuation is observed. These lower levels of attenuation allow acoustic communication systems to achieve much higher data rates than would be possible with underwater radio communication.

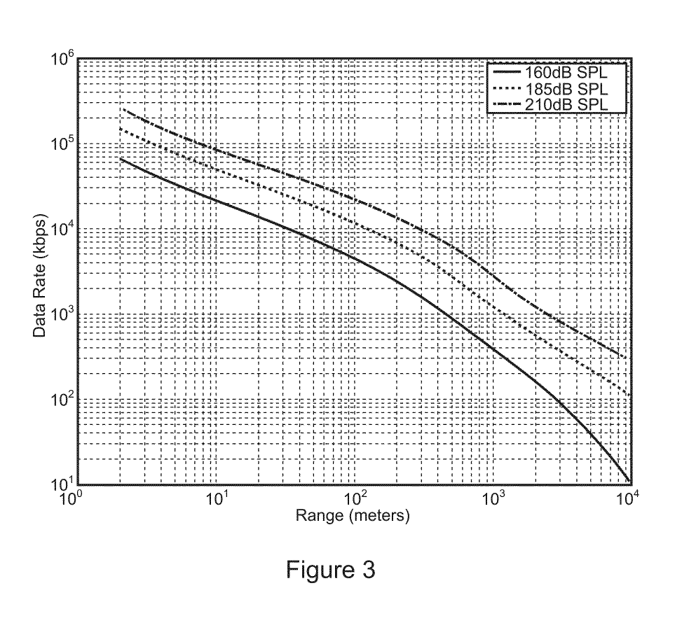

FIG. 3 is a graph showing an example information theoretic capacity of the underwater acoustic channel for different levels of transmit power, e.g., as a function of distance and source power. The transmit power is given as Sound Pressure Level (SPL) at one meter distance from the sound source. This plot does not include the frequency limitations imposed by commercially available acoustic sources but shows the potential of acoustic communication in general without the restrictions imposed by the limitations of hardware. At an SPL of 160 dB, a data rate greater than 4 Mbps can be achieved at a range of 100 m. At an SPL of 210 dB the data rate increases to more than 20 Mbps for the same range. If the characteristics of available acoustic sources and sensors are taken into account data rates will drop, but they remain above 1 Mbps at a range of 100 m. If an off-the-shelf transducer such as the ITC-1089D is used to emit and sense the acoustic signal, the channel capacity is about 1.75 Mbps at 100 m distance.

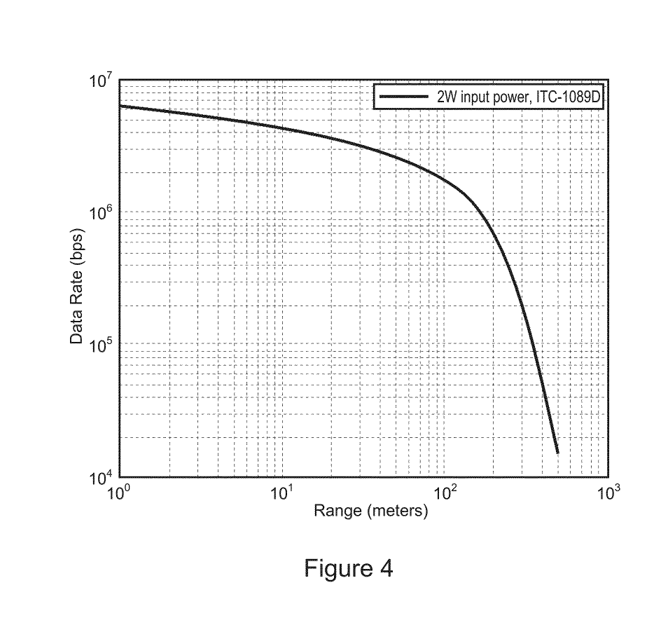

FIG. 4 is a graph of example information theoretic channel capacity between two ITC-1089D transducers using 2 W of input power in sea water as a function of distance. Data rates that can be achieved with the example transducer model are shown at various ranges. These data rates are higher than the achievable subsea radio communication data rates mentioned above. Acoustic communication does not suffer from the issues of free-space optical communication and has significantly more range. Acoustic waves can attenuate more in turbid water than they do in clear seawater, but only marginally so. Acoustic attenuation depends on the concentration of particles suspended in the water. A mass concentration of 1 kgm⁻³ is the extreme case for estuarine and coastal waters. This level of concentration can, for example, be observed in shallow estuarine waters with strong turbulent tidal currents and a bed having fine sand. At peak flow, mass concentrations close to 1 kgm³ have been measured. For this level of concentration the attenuation of a 100 kHz acoustic wave increases from 0.03 dB/m for clear saltwater to 0.04 dB/m. Acoustic communication further does not require that the transmitter and receiver be aligned. Omnidirectional acoustic sources, such as the ITC-1089D transducer, are commercially available and remove the need for alignment. Also, similar hardware, e.g., a ceramic electro-mechanical transducer, can be used for signal emission and reception.

The above capacity calculations ignore multi-path effects and assumed line-of-sight communication between stationary platforms. In this case, the underwater acoustic channel is understood and can be modeled as a linear time-invariant (LTI) system with additive white Gaussian noise (AWGN). A line-of-sight between transmitter and receiver is often available underwater but in a mobile communication scenario the assumption of stationary communication platforms is invalid. There is no consensus on the statistical characterization of this type of time variability and, in the absence of good statistical models for simulation, experimental demonstration of candidate communication schemes remains a de facto standard.

A channel model is described herein for mobile acoustic communication that builds upon the physical principles of acoustic wave propagation and also derives communication algorithms from it to outperform existing acoustic modems by several orders of magnitude. Unlike in mobile radio systems on land, motion-induced Doppler effects is not neglected in acoustic communication systems. Remotely operated underwater vehicles (ROVs) typically move at speeds up to about 1.5 m/s, autonomous underwater vehicles (AUVs) can run at speeds greater than 3 m/s, modern submarines reach speeds greater than 20 m/s, and supercavitating torpedoes propel to speeds of up to 100 m/s. This leads to underwater acoustic Mach numbers v/c (v=vehicle velocity projected onto the signal path between transmitter and receiver, c=wave propagation speed in the medium) on the order of 10⁻² and higher. In comparison, the world's fastest train in regular commercial service, the Transrapid magnetic levitation train, operates at a top speed of 430 km/h. At this speed, the radio communication channel experiences a Mach number of only 4*10⁻⁷, e.g., five orders of magnitude smaller. Relative motion between the transmitter and receiver manifests as time-varying temporal scaling of the received waveform. In radio channels, such Doppler effects are minimal and are correctable under the popular narrowband assumption, while in acoustic communications, they can be catastrophic if not compensated dynamically. Further, when acoustic communication signals have multiple interactions with scatterers underwater, such as the surface or the ocean bottom, harsh multi-path arises.

There are acoustic modems on the market that provide a transparent data link and can reach a net data rate of about 2.5 kbps over 1 km distance, but when they are mobile or multiple signal paths to the receiver exist due to reflective boundaries nearby, these modems perform poorly and only achieve a net data rate of about 100 bps. Multi-path effects are typically most severe when communication signals propagate through a wave guide or in shallow water where both the surface and the bottom reflect the acoustic signal multiple times. Note that horizontal long range communication occurs in a waveguide because waves are always refracted towards the horizontal layer of water at which the speed of sound is lowest. This phenomenon has been described as the Sound Fixing and Ranging (SOFAR) channel.

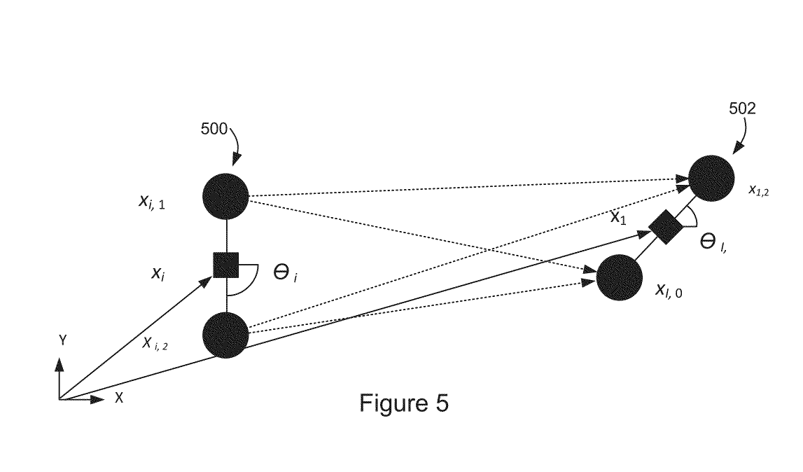

FIG. 5 is a diagram of a transmit array at position xᵢ with orientation θᵢ and a receive array at position xₗ with orientation θₗ. As used herein, the set of integers is denoted by [symbol] and [symbol] +={z∈ [symbol] :z≧0}. The sets of real and complex numbers are denoted by [symbol] and [symbol] , respectively. The set [symbol] >{x∈ [symbol] :x>0} and [symbol] ≧={x∈ [symbol] :x≧0}. The sets [symbol] < and [symbol] ≦ are determined analogously. The set [j: n] denotes {z∈ [symbol] :j≦z≦n} with [n]≡[1: n]. For any complex number x, x* denotes the conjugate of x. For any function x: [symbol] → [symbol] , the function \dot{x}(t) denotes its first derivative and x^{(k)}(t) its k-th derivative. The real number ∥x∥ denotes the Euclidean norm of the vector x. When A is a matrix of dimension n×m, then A_{[i:j],[l:k]} denotes the matrix B of dimension 1+j−i x×1+k−1 where B_{p,q}=A_{i-1+p,l-1+q}.

Acoustic communication uses acoustic waves to carry information. To communicate digital information acoustically, a digitized waveform is converted into an electrical signal by a suitable waveform generator circuit and this electrical signal is then amplified and delivered to an acoustic transducer. The electrical signal stimulates the transducer to vibrate. The resulting pressure fluctuations in the medium create an acoustic signal that radiates off the transducer and propagates through the water. The transducer is typically a piezo-electric ceramic encapsulated in plastic. This type of transducer can be used for both the transmission and the reception of acoustic signals. It converts electrical signals into acoustic signals and vice versa. When a transducer is used for transmission, it is often referred to as a projector. When it is used as a receiver, it is usually called a hydrophone. At some distance from projector, the hydrophone is stimulated by the incident pressure fluctuations and generates an electrical signal. The measured electrical signal is amplified and digitized by another suitable circuit.

Given a point of reference, the position and orientation of a transducer array is determined by a six dimensional vector describing the translation in three perpendicular axes combined with the rotation about three perpendicular axes, the six degrees of freedom (6DoF). A channel model described herein explicitly models these states for the transmit and the receive array. In FIG. 5, a transmit array 500, e.g., transmitter, is at position xi with orientation θᵢ a and a receive array 502, e.g., receiver, is at position x₁ with orientation θ₁. When there are multiple acoustic signal paths from the transmitting array to the receive array due to reflection off nearby boundaries, each propagation path is modeled as a line of sight path from a phantom source with its own position and orientation.

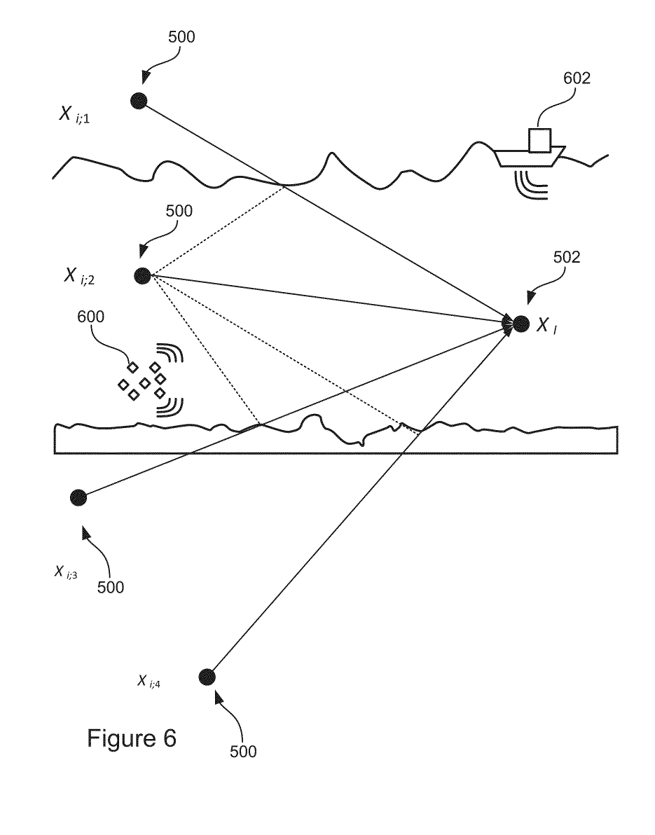

FIG. 6 is a diagram illustrating an example of multi-path effects with each path interpreted as a line of sight path to a phantom source. The p-th phantom source appears to be at position x_{i;p}(t) with orientation θ_{i;p}(t). Along each path, some dispersion is induced due to the frequency dependent absorption loss. Each 6DoF vector, as well as the attenuations along each path are modeled as a continuous time random process. These states are observed through the acoustic pressure measurements of the receive hydrophone arrays 502 and also possibly through inertial sensors mounted onto the transmit 500 and receive array 502. Inference based on this model yields position estimates and if the sent signals are used for communication and are unknown at the receiver 502, they can be modeled as random processes and be estimated as well. The receiver 502 then performs positioning and data detection jointly. There may also be a connection with beam-forming. Emitted wave fronts may arrive at different times on the elements of the receiver array 502. The receiver algorithm described below obtains estimates of these arrival times and then compensates the received signals such that they add constructively, a technique that can be similar to broadband receive beam-forming. Additionally or alternatively, transmit beam-forming can be performed based upon the known location of the receiver 502. This has the potential to mitigate multi-path in short range channels.

A model of the acoustic channel is established below that is sophisticated enough to capture the dominant physical effects but simple enough to allow computationally tractable inference. Beginning from principles of acoustic wave propagation, the acoustic signal path is considered starting at the projector array 500 and ending at the receive hydrophone array 502 as the communication channel, e.g. from sending node 600, e.g., sending vehicle, to receiving node 602, e.g., receiving vehicle. Assume that there is only one transducer element on the transmit array 500 and receive array 502 and that their positions are x₁(t) and x₂(t), respectively, which depend on the time t. The transmitter 500 emits the acoustic signal \tilde{s}₁(t) and the receiver 502 senses the acoustic signal \tilde{r}₂(t). If these elements are operating in an ideal fluid, where energy was conserved and there was no absorption loss and no ambient noise, the acoustic wave equation describes the channel:

$$\frac{1}{{c}^{2}} \frac{{\partial }^{2} p}{\partial {t}^{2}} - Δ p = 4 π \frac{\partial }{\partial t} \{ δ ( x - {x}_{1} ( t ) ) {\int }_{- ∞}^{t} {\tilde{s}}_{1} ( τ ) d τ \} \qquad ( Equation 2 )$$

where p(x, t) is the sound pressure at position x and time t, c is speed of sound and A denotes the Laplace operator. Assuming there are no reflective boundaries and both transmitter and receiver move subsonically, the far field solution to this equation at position x₂(t) is

$${p}^{FF} ( {x}_{2} ( t ) , t ) = \frac{{( \frac{\partial {t}_{e}}{\partial t} )}^{2}}{‖ {x}_{2} ( t ) - {x}_{1} ( {t}_{e} ) ‖} {\tilde{s}}_{1} ( {t}_{e} ) \qquad ( Equation 3 \}$$

where tₑ is the unique solution to the implicit equation

$$t - {t}_{e} - \frac{‖ {x}_{2} ( t ) - {x}_{1} ( {t}_{e} ) ‖}{c} = 0 \qquad ( Equation 4 )$$

The time te is often called the emission time or retarded time. Neglecting the near field component of the solution, set \tilde{r}₂(t)=p^{FF}(x²(t),t). This relationship completely describes the communication channel under the mentioned assumptions. Write

\tilde{r}₂(t)=h(t)\tilde{s}₁(tₑ) (Equation 5)

and consider h(t) a time dependent channel gain factor. Taking a close look at Equation 3, notice that the gain h(t) is inversely proportional to the communication distance. Further the “Doppler factor”

$$\frac{\partial {t}_{e}}{\partial t}$$

is always positive, equal to unity when there is no motion, greater than unity when the source and receiver are moving towards each other and smaller than unity otherwise.

The solution tₑ to Equation 4 can be interpreted as a fixed-point and can be computed by a fixed-point iteration algorithm.

In one embodiment, theorem 1 can be utilized. Assume there are two functions \dot{x}₁(t): [symbol] → [symbol] ₃ and \dot{x}₂ (t): [symbol] → [symbol] ³, and that \dot{x}₁(t) is continuously differentiable and ∥\dot{x}₁(t)|<c. Determine the function

$${F}_{t} ( {t}_{3} ) = t - \frac{1}{c} ‖ {x}_{2} ( t ) - {x}_{1} ( {t}_{e} ) ‖ \qquad ( Equation 6 )$$

Then for any t and tₑ[0], the sequence tₑ [n], n=0, 1, 2, . . . with

tₑ[n+1]=Fₜ(tₑ[n]),n=0,1,2, . . . (Equation 7)

converges to a real number tₑ(t). This number is the unique solution to the implicit equation tₑ=Fₜ(tₑ), which is equivalent to Equation 4.

Proof: (x)=∥x∥ is a continuous function and derive

$$\begin{matrix}\begin{matrix}\frac{d}{d t} ‖ {x}_{1} ( t ) ‖ = {lim}_{δ \to 0} \frac{‖ {x}_{1} ( t + δ ) ‖ - ‖ {x}_{1} ( t ) ‖}{δ} \\ \leq {lim}_{δ \to 0} ‖ \frac{{x}_{1} ( t + δ ) - {x}_{1} ( t )}{δ} ‖ ( Equation 9 ) \\ = {lim}_{δ \to 0} ‖ \frac{{x}_{1} ( t + δ ) - {x}_{1} ( t )}{δ} ‖ ( Equation 10 ) \\ = ‖ {\dot{x}}_{1} ( t ) ‖ ( Equation 11 )\end{matrix} \\ and & ( Equation 8 ) \\ \begin{matrix}- \frac{d}{d t} ‖ {x}_{1} ( t ) ‖ = {lim}_{δ \to 0} \frac{- ‖ {x}_{1} ( t + δ ) ‖ + ‖ {x}_{1} ( t ) ‖}{δ} \\ \leq {lim}_{δ \to 0} ‖ \frac{{x}_{1} ( t + δ ) - {x}_{1} ( t )}{δ} ‖ ( Equation 13 ) \\ = ‖ {\dot{x}}_{1} ( t ) ‖ ( Equation 14 )\end{matrix} & ( Equation 12 )\end{matrix}$$

for any t∈ [symbol] . The inequalities follow from the triangle inequality. So

$$\vert \frac{d}{d t} ‖ {x}_{1} ( t ) ‖ \vert \leq ‖ {\dot{x}}_{1} ( t ) ‖ .$$

### Further,

$$\begin{matrix}\vert \frac{d}{d {t}_{e}} {F}_{t} ( {t}_{e} ) \vert = \frac{1}{c} \vert \frac{d}{d {t}_{e}} ‖ {x}_{2} ( t ) - {x}_{1} ( {t}_{e} ) ‖ \vert \\ \leq \frac{1}{c} ‖ {\dot{x}}_{1} ( {t}_{e} ) ‖ < 1 ( Equation 16 )\end{matrix} \qquad ( Equation 15 )$$

The function Fₜ(tₑ) is hence a contraction mapping in tₑ. By the Banach fixed-point theorem, there exists an unique tₑ that solves the equation Fₜ(tₑ)=tₑ and the sequence tₑ [n], n=0, 1, 2, . . . converges to this solution. The implicit equation Fₜ(tₑ)=tₑ is equivalent to Equation 4.

The absence of absorption was assumed in the derivation of Equation 5. In reality, emitted acoustic signals experience attenuation due to spreading and absorption, e.g., thermal consumption of energy. The absorption loss of acoustic signals in sea water increases exponentially in distance and super exponentially in frequency. The loss due to spreading is in principle the same as in electromagnetics. The total attenuation of the signal power is given by

$$A ( l , f ) = \frac{{\vert {\tilde{S}}_{1} ( f ) \vert}^{2}}{{\vert {\tilde{R}}_{2} ( f ) \vert}^{2}} = {l}^{k} {a ( f )}^{l - 1} \qquad ( Equation 17 )$$

where f is the signal frequency, l is the transmission distance and \tilde{S}₁(f) and \tilde{R}₂ (f) are the Fourier transforms of the signals \tilde{s}₁ (t) and \tilde{r}₂ (t), respectively. The exponent k models the spreading loss. If the spreading is cylindrical or spherical, k is equal to 1 or 2, respectively. Several empirical formulas for the absorption coefficient a(f)) have been suggested. Marsh and Schulkin conducted field experiments and derived the following empirical formula to approximate 10 log₁₀ a(f)) in sea water at frequencies between 3 kHz and 0.5 MHz:

$$10 {log}_{10} a ( f ) \approx 8.68 \cdot {10}^{3} ( \frac{S {Af}_{T} {f}^{2}}{{f}_{T}^{2} + {f}^{2}} + \frac{{Bf}^{2}}{{f}_{T}} ) ( 1 - 6.54 \cdot {10}^{- 4} P ) [ db \text{/} km ] \qquad ( Equation 18 )$$

where A=2.34·10⁻⁶, B=3.38·10⁻⁶, S is salinity in promille, P is hydrostatic pressure [kg/cm²], f is frequency in kHz and

f_{T}=2.19·10^{6-1520/(T+273)} (Equation 19)

is a relaxation frequency [kHz], with T the temperature [° C.].

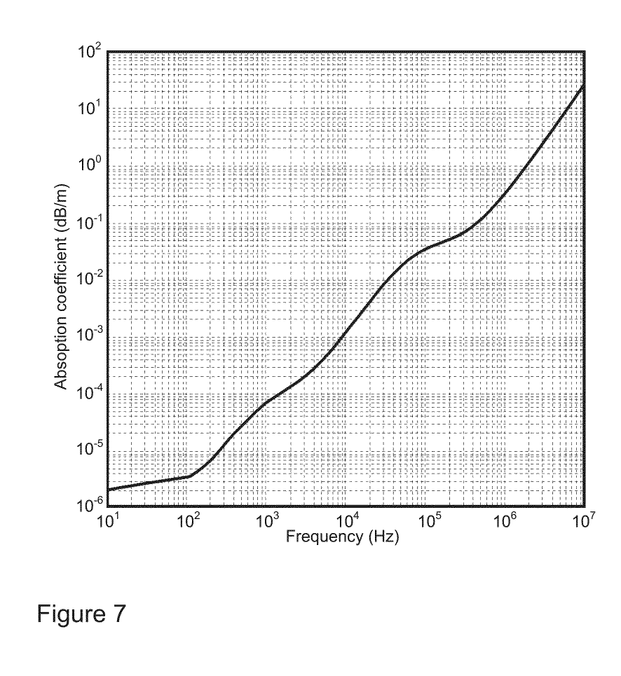

FIG. 7 is a graph of an example absorption coefficient, 10 log₁₀ a(f) in dB/m. In FIG. 7, a composite plot uses the formulas and illustrates the dependency of 10 log₁₀ a(f)) on frequency for a salinity of 35 promille, a temperature of 5° C. and a depth of 1000 m. The bandwidth available for communication is severely limited at longer distances. For shorter distances, the bandwidth of the transducer becomes the limiting factor. A 1 MHz sine wave experiences a 31.89 dB absorption loss over 100 m distance and a 318.9 dB absorption loss over 1 km distance. From Equation 17, for a fixed transmission distance 1, signal attenuation is linear and time-invariant. When the transmitter or the receiver move, signal attenuation is a linear effect, but it varies with time. The received acoustic signal can hence be related to the emitted acoustic signal by a time-varying convolution integral with kernel h(t, τ). The following extension to the channel model from Equation 5 takes this time-varying signal attenuation into account:

\tilde{r}₂(t)∫_{τ}^{t}h(t,τ)\tilde{s}₁(tₑ(t)−τ)dτ (Equation 20)

Acoustic channel observations in reality also contains some noise. There is ambient noise and site-specific noise. Site-specific noise is for example caused by underwater machines or biologics. Ambient noise arises from wind, turbulence, breaking waves, rain and distant shipping. The ambient noise can be modeled as a Gaussian process but has a colored spectrum. At low frequencies (0.1-10 Hz), the main sources are earthquakes, underwater volcanic eruptions, distant storms and turbulence in the ocean and atmosphere. In the frequency band 50-300 Hz, distant ship traffic is the dominant noise source. In the frequency band 0.5-50 kHz the ambient noise is mainly dependent upon the state of the ocean surface (breaking waves, wind, cavitation noise). Above 100 kHz, molecular thermal noise starts to dominate. The power spectral density of the ambient noise can be measured and modeled. Researcher Coates breaks the overall noise spectrum N (f) up into a sum of four components: The turbulence noise Nₜ(f), the shipping noise Nₛ(f), surface agitation noise N_{w}(f) and the thermal noise Nₜₕ(f). These noise spectra are given in μPa²/Hz as a function of frequency in kHz:

10 log₁₀ Nₜ(f)=17−30 log₁₀(f) (Equation 21)

10 log₁₀ Nₛ(f)=40+20(s−0.5)+26 log₁₀(f)−60 log₁₀(f+0.03) (Equation 22)

10 log₁₀ N_{w}(f)=50+7.5w^{1/2}+20 log₁₀(f)−40 log₁₀(f+0.4) (Equation 23)

10 log₁₀ Nₜₕ(f)=−15+20 log₁₀(f) (Equation 24)

and sum up to give the total ambient noise N (f)

N(f)=Nₜ(f)+Nₛ(f)+N_{w}(f)+Nₜₕ(f). (Equation 25)

In this empirical expression, s is the shipping activity factor taking values between 0 and 1 and w is the wind speed in m/s.

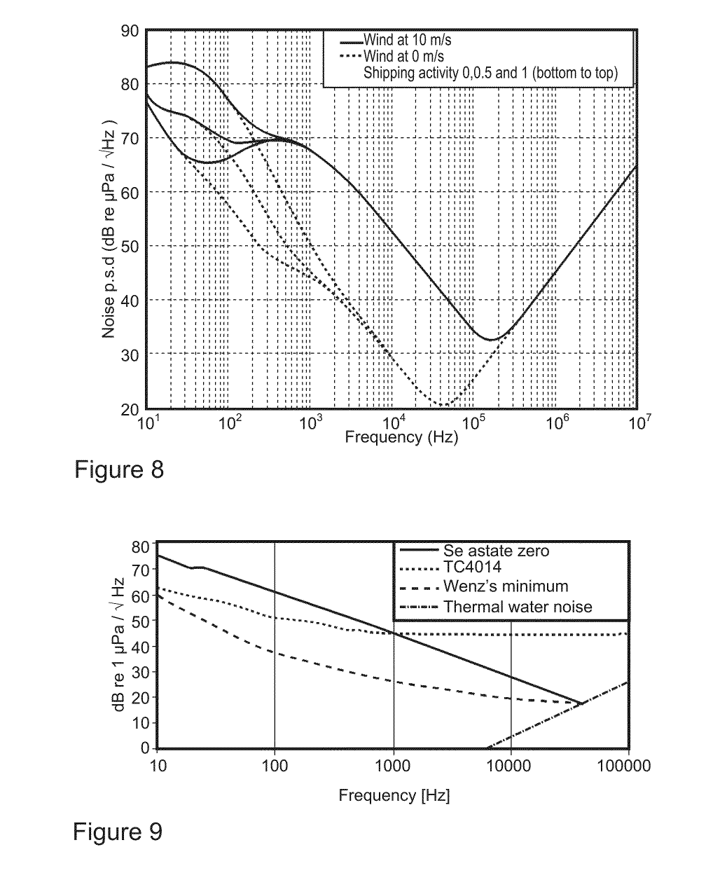

FIG. 8 is a graph of an example power spectral density of the ambient noise, N(f), in (dB re μPa/\sqrt{Hz}). FIG. 8 plots N(f)) for different values of s and w. The ambient noise and the signal originating from the transmitter add at the receiver. Determining \tilde{v}(t) to be an independent Gaussian random process with power spectral density given by N (f), the channel model from Equation 20 can be further refined to:

\tilde{r}₂(t)∫_{τ}^{t}h(t,τ)\tilde{s}₁(tₑ(t)−τ)dτ+\tilde{v}(t). (Equation 26)

So far the acoustic signal path starting at the projector and ending at the receive hydrophone has been considered as the channel. But in reality, the involved transducers and amplifiers also shape the signal and introduce noise. The notion of the communication channel to encompass the distortion effects of the involved amplifiers and transducers can be extended as well. The effect of any frequency response shaping can be absorbed into the kernel h(t, τ). But at the receiver also significant electronic noise is added. The voltage generated by a hydrophone in response to an incident acoustic signal is small and is pre-amplified to better match the voltage range of the digitizer. The electronic noise produced at the input stage of the preamplifier depends upon the capacitance of the hydrophone, but is usually so high that it dominates the acoustic ambient noise picked up by the hydrophone. The most sensitive high frequency hydrophones by market leading companies ITC and RESON introduce self-noise of at least 45 dB re μPa/\sqrt{Hz} referred to input.

FIG. 9 is a graph of typical self-noise referred to input of the Reson TC4014 broad band spherical hydrophone. A typical self-noise referred to input of the Reson TC4014 broad band spherical hydrophone is compared to seastate zero ambient noise, e.g., the ambient noise when wind waves and swell levels are minimal. Comparing FIGS. 8 and 9, notice that even for high levels of wind, the hydrophone self-noise dominates the ambient noise at frequencies above about 20 kHz. Since the acoustic projectors most suited for broadband communication do not cover frequencies below about 10 kHz, assume that the electronic noise dominates the ambient noise. The electronic noise is well approximated by an independent Gaussian noise process with flat power spectral density in the band of interest. Therefore, assume that \tilde{v}(t) is such a process. To model transmission involving transmit and receive arrays with multiple transducers and consider multi-path effects arising from reflections off nearby scatterers, the model can fix a Cartesian frame of reference at a known location in space.

Positions and angles are given with respect to this reference system. Assume xᵢ(t) and θᵢ(t) are the three dimensional position and orientation vectors of the i-th transducer array. The total number of available arrays depends on the scenario but the model can start indexing them with the integer 1. Two types of arrays include: A trivial array with only one element and a non-trivial array with K elements and fixed geometry. There is a function T: [symbol] ⁶→ [symbol] ³×K that maps the position xᵢ(t) and orientation θᵢ(t) of the i-th array to the positions x_{i,j} (t), j∈[K], of its omnidirectional elements. FIG. 5 applies this notation.

The j-th transducer of the i-th array sends the signal \tilde{s}_{i,j} (t) and receives \tilde{r}_{i,j} (t). Assume there is no multiple access interference (MAI). So, in case there is no multi-path but only a line of sight, the received signals can be expressed as

\tilde{r}_{l,m}(t)Σⱼ∫_{τ}^{t}h_{i,j;l,m}(t,τ)\tilde{s}_{i,j}(t_{i,j;l,m}(t)−τ)dτ+\tilde{v}_{l,m}(t) (Equation 27)

where h_{i,j;l,m}(t, τ) denotes the time-varying signal attenuation kernel along the path from the j-th transducer of the i-th array to the m-th transducer of the 1-th array, t_{i,j;l,m}(t) is the unique solution to the implicit equation

$$t - {t}_{i , j ; l , m} - \frac{‖ {x}_{l , m} ( t ) - {x}_{i , j} ( {t}_{i , j ; l , m} ) ‖}{c} = 0 , \qquad ( Equation 28 )$$

and the \tilde{v}_{l,m}(t) are independent Gaussian noise processes with flat power spectral density in the band of interest. When there is multi-path, interpret each path as the line of sight path from a phantom source array at position x_{i;p}(t) and orientation θ_{i;p(t)}, p∈[P_{i;l}], that sends out the same signals. The integer P_{i;l} counts the number of paths present between array i and l. FIG. 6 shows the real source and three phantom sources, one for each reflection. In the multi-path case, the received signals read

\tilde{r}_{l,m}(t)=Σ_{j∈[K],p∈P}_{_{i;l}}∫_{τ}^{t}h_{i,j;p;l,m}(t,τ)\tilde{s}_{i,j}(t_{i,j;p;l,m}(t)−τ)dτ+\tilde{v}_{l,m}(t) (Equation 29)

where t_{i,j;p;l,m}(t) is the unique solution to the implicit equation

$$t - {t}_{i , j ; p ; l , m} - \frac{‖ {x}_{l , m} ( t ) - {x}_{i , j ; p} ( {t}_{i , j ; p ; l , m} ) ‖}{c} = 0 , \qquad ( Equation 30 )$$

x_{i;p}(t), j∈[K], are the positions of the transducer elements on the p-th phantom array and h_{i,j;p;l,m}(t, τ) denotes the time-varying signal attenuation kernel along the path from the j-th transducer of the p-th phantom of the i-th array to the m-th transducer of the 1-th array.

For signal design and sampling, as described herein waveforms that can be designed that are suitable for bandwidth efficient data communication and channel estimation. Standard single carrier source signals are well-suited for this task. It is possible to detect and track motion from the phase margin or lag with respect to the carrier (center frequency). Furthermore, modulation of the phase can be used to embed data. An approach to construction of such a communication signal is through varying the amplitude and phase of a collection of basis functions with limited bandwidth. Suppose the j-th transducer of the i-th array is to transmit length N+1 sequences of symbols s_{i,j} [n], n∈[0:N], from a finite set of signal constellation points A⊂ [symbol] . To this end, the sequence s_{i,j} [n] is mapped to a waveform s_{i,j} (t): [symbol] →

[symbol]

s_{i,j}(t)=Σ_{l∈[0:N]}s_{i,j}[l]p(t−lT) (Equation 31)

by use of a basic pulse p(t) time shifted by multiples of the symbol period T. The pulse p(t) is typically assumed to have a bandwidth of no more than 1/T. If some of these symbols are unknown, they can usually be assumed to be i.i.d., either because the underlying symbols have been optimally compressed or randomly interleaved. This signal is then modulated to passband

\tilde{s}_{i,j}(t)=2Re{s_{i,j}(t)e^{2π\sqrt{-1}f}^{_{Ci}}^{t}} (Equation 32)

at carrier frequency f_{Ci}. These frequencies are chosen such that there is no Multiple Access Interference (MAI), e.g., |f_{Ci}−f_{Ci′}|>1/T for all i≠i′.

At the receiving array, the signal \tilde{r}_{l,m}(t) from Equation 29 is demodulated by fCi and low-pass filtered, which yields

$${r}_{l , m} ( t ) = {\sum }_{j , p} {\int }_{τ}^{t} {h}_{i , j ; p ; l , m} ( t , τ ) {e}^{2 π \sqrt{- 1} {f}_{Ci} ( {t}_{i , j ; p ; l , m} ( t ) - τ - t )} {s}_{i , j} ( {t}_{i , j , p ; l , m} ( t ) - τ ) d τ + {v}_{l , m} ( t ) \qquad ( Equation 33 )$$

where v_{l,m}(t) denotes the demodulated and filtered noise processes. Motion-induced

Doppler shifts compress and/or dilate, e.g., widen, the bandwidth of the received signal. If the low-pass filter had only a bandwidth of 1/T a significant fraction of the signal could be lost. Assume that vₘₐₓ is the maximal experienced speed. The maximum frequency of the emitted signal is designed to be f_{Ci}+½T and a sinusoid with that frequency would then experience a Doppler shift of at most

$${f}_{di} = ( {f}_{Ci} + 1 / 2 T ) \frac{{v}_{max}}{c} .$$

Hence increase the cut-off frequency of the low-pass filter by f_{di} and sample the filtered signal at the increased frequency 1/Ti=1/T+2f_{di}. The samples may be stored in memory, in a circular buffer in hardware, etc. The sampled output equations read

$${r}_{l , m} [ n ] = {\sum }_{j , p , k} {h}_{i , j ; p ; l , m} [ n , k ] {e}^{2 π \sqrt{- 1} {f}_{Ci} ( {t}_{i , j ; p ; l , m} [ n ] - {nT}_{i} )} {s}_{i , j} ( {t}_{i , j , p ; l , m} [ n ] - k {T}_{i} ) + {v}_{l , m} [ n ] \qquad ( Equation 34 )$$

where t_{i,j;p;l,m}[n]=t_{i,j;p;l,m}(nTᵢ), v_{l,m}[n] is the sampled noise process and

h_{i,j;p;l,m}[n,k]=Tᵢh_{i,j;p;l,m}(nTᵢ,kTᵢ)e^{-2π\sqrt{-1}f}^{_{Ci}}^{kT}^{ᵢ} (Equation 35)

is the demodulated and sampled kernel. The original noise process v_{l,m}(t) was Gaussian and white in the band of interest and hence the noise samples v_{l,m} [n] are i.i.d. Gaussian.

An objective is to communicate data sequences to the receiver, that is parts of the sequences s_{i,j} [1] are unknown and to estimate them from the available observations r_{l,m} [n]. Unfortunately, the kernels h_{i,j;p;l,m}[n, k] as well as the position and orientation vectors of the transmit and receive arrays are unknown as well. A possible approach to this is to model all these states probabilistically and then perform Bayesian estimation and estimate all these states jointly. The following probabilistic model of attenuation can be used.

The channel gains h_{i,j;p;l,m}[n] are random and assume their evolution is described by the following state equations:

h_{i,j;p;l,m}[n+1,k]=λh_{i,j;p;l,m}[n,k]+u_{i,j;p;l,m},[n,k] (Equation 36)

where, for each choice of the indices i, j, p, l, m and k, the random variables u_{i,j;p;l,m}[n, k] form an independent white Gaussian noise process in n with variance σᵤ². The parameter λ∈(0, 1) is the forgetting factor. More sophisticated a priori models for the evolution of these gains could be used. For a simpler model, neglect the dependence of the length and the attenuation of the involved signal propagation paths.

For probabilistic modeling of receiver motion, various motion models have been considered in the position tracking literature. There are discrete time and continuous time models. The channel observations r_{l,m}[n] depend on transmitter and receiver motion only through the emission time t_{i,j;p;l,m}[n] which, by definition, is the solution to the implicit Equation 30 for t=nTi. The emission time is only influenced by the values of the functions xₗ(t) and θₗ(t) where t=nTi, n=0, 1, 2, . . . , and hence model the evolution of the receiver position and orientation in discrete time. Among the commonly used discrete time motion models, the discrete d-th order white noise model is among the simplest. In this model, each coordinate x_{l;k}(t) of the vector xₗ(t) is uncoupled and for each coordinate, k, the d-th derivative x_{l;k}^{(d)}(t) is right-continuous and constant between sampling instants and x_{l;k}^{(d)}[n]=x_{l;k}^{(d)}(nTᵢ), n=0, 1, 2 . . . , is a white Gaussian noise process with variance σₐ². Iterated integration of xₖ^{(d)}(t) and sampling with period Tᵢ yields the following linear discrete time state equations with Toeplitz transition matrix:

$$( \begin{matrix}{x}_{l ; k} [ n + 1 ] \\ {x}_{l ; k}^{( 1 )} [ n + 1 ] \\ ⋮ \\ {x}_{l ; k}^{( d - 1 )} [ n + 1 ]\end{matrix} ) = ( \begin{matrix}1 & {T}_{i} & … & \frac{{T}_{i}^{d - 1}}{( d - 1 )} \\ 0 & ⋱ & ⋱ & \end{matrix} ) ( \begin{matrix}{x}_{l ; k} [ n ] \\ {x}_{l ; k}^{( 1 )} [ n ] \\ ⋮ \\ {x}_{l ; k}^{( d - 1 )} [ n ]\end{matrix} ) + ( \begin{matrix}\frac{{T}_{i}^{d}}{d} \\ ⋮ \\ {T}_{i}\end{matrix} ) \qquad ( Equation 37 )$$

where an is an independent white Gaussian noise process with variance σₐ² and d>1. Other more sophisticated motion models for example allow correlation across coordinates and take into account on-line information about the maneuver but postpone a more detailed modeling. Further, the orientation and position of an array are often correlated. Vehicles typically move into the direction of the orientation vector. For simplicity, postpone the modeling of this effect as well and assume orientation and position to evolve independently but to share the same probabilistic model.

For probabilistic modeling of transmitter motion, again, the channel observations r_{l,m}[n] depend on transmitter motion only through the emission time t_{i,j;p;l,m}[n]. If both the position x_{i;p}(t) and the orientation θ_{i;p}(t) of the (phantom) transmit array are modeled by random processes with continuous sample paths and their speed is bounded by a sufficiently small value, then the positions x_{i,j;p}(t), j∈[K], p∈[P_{i;l}], of its array elements also have continuous sample paths and their speed is less than the speed of sound. In that case, by Theorem 1, there is a unique solution t_{i,j;p;l,m}[n] to the implicit Equation 30 for t=nTi and each array element j∈[K] and path p∈[P_{i;l}]. Note that the emission times t_{i,j;p;l,m}[n], j∈[K], p∈[P_{i;l}] can be viewed as hitting times

$$( {t}_{i , j ; p ; l , m} ) [ n ] = inf \{ {t}_{e} \text{:} \frac{‖ {x}_{l , m} ( {nT}_{i} ) - {x}_{i , j ; p} ( {t}_{e} ) ‖}{c} + {t}_{e} = {nT}_{i} \} . \qquad ( Equation 38 )$$

In one example, model each coordinate of the transmitter position x_{i;p}(t) and orientation θ_{i;p} (t) as independent strong Markov processes. More specifically, model the evolution of each coordinate by a bidimensional random process, the first dimension is a speed process, modeled as a Brownian motion reflected off a symmetric two-sided boundary, and the second dimension is the position process, which is the integral of the first dimension. For this setup, conjecture that the vector (x_{i;p}(t), \dot{x}_{i;p}(t), θ_{i;p} (t), \dot{θ}_{i;p}(t)) describes a Feller process and that the set of states

{(x_{i;p}(t),\dot{x}_{i;p}(t),θ_{i;p}(t),\dot{θ}_{i;p}(t)),t=t_{i,j;p;l,m}[n],j∈[K]} (Equation 39)

indexed by the discrete time variable n, form a Markov chain of order R for each p∈[P_{i;l}] given the receiver motion. The order R depends on the array geometry and the maximal speed of the above mentioned Brownian motion speed processes. This conjecture is proved for some special cases and it is discussed on how these proofs could be extended to cover the general case. The first special case look at is that of one dimensional motion on a line with one element transmit and receive arrays.

Let the random processes xᵢ(t) and xᵢ(t) denote the position of the transmitter and receiver on the real line at time t, respectively. The simple model presented in Equation 36 may not be sufficient when transmitter motion is allowed. It would allow the transmitter and receiver to get arbitrarily high velocities with non-zero probability, leading to supersonic speed and non-unique emission times. Transmitter speed needs to be bounded in order for Theorem 1 to guarantee unique emission times. Further, receiver speed needs to be bounded, in order for the emission times tₑ[n] to form a strictly increasing sequence. This is a condition for the bidimensional process (xᵢ (tₑ [n]), \dot{x}ᵢ(tₑ [n])) to be Markov in n. The following definitions and theorems make these points more precise and give an approximation of the transition kernel of the Markov chain (xᵢ (tₑ [n]), \dot{x}ᵢ (tₑ [n])).

Drive the motion model by a Brownian motion.

Definition 1. A stochastic process B(t), t∈ [symbol] ≧0, is called a Brownian motion if

1. B(0)=0

2. B(t) is continuous almost surely

3. B(t) has independent increments

4. B(t)−B(s)˜N (0, t−s) for 0≦s<t, where N (0, t−s) is the normal distribution with zero mean and variance t−s.

The following motion model uses Brownian motion as the speed process, gives continuous sample paths, is strongly Markov, has Gaussian distributed independent increments and its hitting time distribution.

Definition 2. (Integrated Brownian motion (IBM) model) For any non-negative time t E [symbol] >0, the position of the transmitter is given by

x(t)=x₀+∫₀^{t}\dot{x}(τ)dτ, (Equation 40)

where the speed process \dot{x}(t) is given by

\dot{x}(t)=\dot{x}ₒ+αB(t), (Equation 41)

the values x₀, \dot{x}ₒ∈ [symbol] and α∈ [symbol] _{>o}, are model parameters and B(t) is a Brownian motion as in Definition 1. For any negative time t, x(t)=x₀+\dot{x}ₒt and \dot{x}(t)=\dot{x}₀. The bidimensional process ξ(t)=(x(t),\dot{x}(t)) determines the integrated Brownian motion (IBM) model.

A problem with this motion model is that speed is unbounded and hence emission times can become non-unique. A motion model is described herein that gives position sample paths whose speed is bounded by some value smaller than the speed of sound so that there is a unique emission time. The above speed process is reflected off a symmetric two sided boundary to ensure it is bounded almost surely.

Definition 3. (Integrated reflected Brownian motion (IRBM) model) For any non-negative time t∈ [symbol] _{>o}, the position of the transmitter is given by

x(t)=x₀+∫₀^{t}\dot{x}(τ)dτ, (Equation 42)

where the speed process \dot{x}(t) is given by

\dot{x}(t)=g(\dot{x}₀+αB(t)) (Equation 43)

the values x₀, \dot{x}₀∈ [symbol] and α∈ [symbol] _{>0} are model parameters and B(t) is a Brownian motion as in Definition 1. Therefore:

g(\dot{x})=(−1)^{n(\dot{x})}(\dot{x}−2\dot{x}ₘₐₓn(\dot{x})), (Equation 44)

where

$$n ( \dot{x} ) = ⌊ \frac{\dot{x}}{2 {\dot{x}}_{max}} ⌉ ,$$

the operator └•┐ denotes rounding to the nearest integer and \dot{x}ₘₐₓ∈ [symbol] _{>0} bounds |\dot{x}(t)|. Both |\dot{x}₀| and \dot{x}ₘₐₓ are chosen to be smaller than the speed of sound c. For any negative time t, x(t)=x₀+\dot{x}₀t and \dot{x}(t)=\dot{x}₀. The bidimensional process (t)=(x(t),\dot{x}(t)) determines the integrated reflected Brownian motion (IRBM) model.

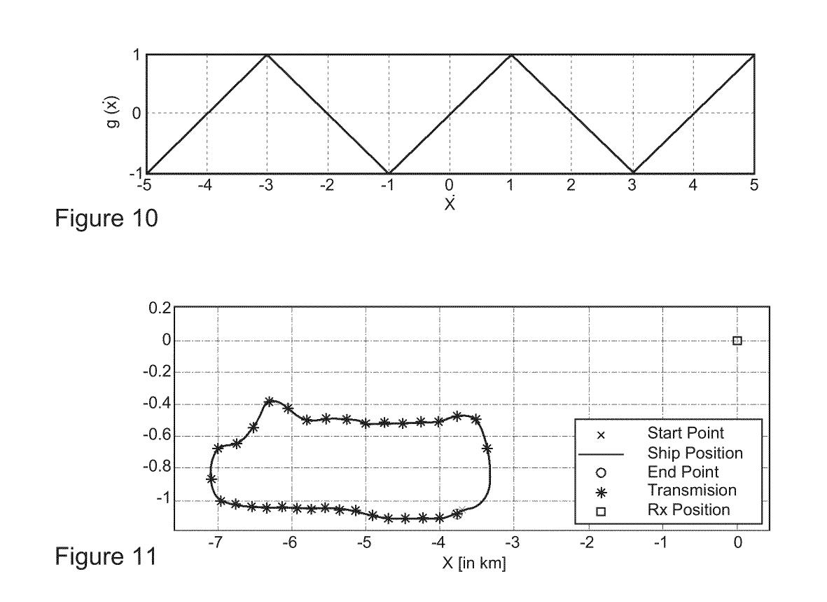

FIG. 10 is a graph of an example operation of the function g(\dot{x}) from Definition 3 for \dot{x}ₘₐₓ=1. For any function \dot{x}(t), the function g(\dot{x}(t)) reflects values greater than \dot{x}ₘₐₓ inwards. The operation of the function g(\dot{x}) is illustrated for \dot{x}ₘₐₓ=1. The function g(\dot{x}) has a property utilized in Theorem 2 below.

Lemma 1. If g(\dot{x}) and n(\dot{x}) are the functions defined in Equation 44 in Definition 3 for some \dot{x}ₘₐₓ>0, then

g((−1)^{m}\dot{x}+2\dot{x}ₘₐₓm)=g\dot{x} (Equation 45)

for any integer m.

Proof.

$$\begin{matrix}n ( ( - 1 ) {}^{m} \dot{x} + 2 {\dot{x}}_{max} m ) = ⌊ \frac{( - 1 ) {}^{m} \dot{x} + 2 {\dot{x}}_{max} m}{2 {\dot{x}}_{max}} ⌉ \\ = m + {( - 1 )}^{m} ⌊ \frac{\dot{x}}{2 {\dot{x}}_{max}} ⌉ ( Equation 47 )\end{matrix} \qquad ( Equation 46 )$$

and hence

$$g ( {( - 1 )}^{m} \dot{x} + 2 {\dot{x}}_{max} m ) = ( - 1 ) {}^{m + {( - 1 )}^{m} ⌊ \frac{\dot{x}}{2 {\dot{x}}_{max}} ⌉} ( {( - 1 )}^{m} \dot{x} + 2 {\dot{x}}_{max} m - 2 {\dot{x}}_{max} ( m + {( - 1 )}^{m} ⌊ \frac{\dot{x}}{2 {\dot{x}}_{max}} ⌉ ) ) = {( - 1 )}^{m + {( - 1 )}^{m} ⌊ \frac{\dot{x}}{2 {\dot{x}}_{max}} ⌉} ( {( - 1 )}^{m} \dot{x} - 2 {{\dot{x}}_{max} ( - 1 )}^{m} ⌊ \frac{\dot{x}}{2 {\dot{x}}_{max}} ⌉ ) = {( - 1 )}^{{( - 1 )}^{m} ⌊ \frac{\dot{x}}{2 {\dot{x}}_{max}} ⌉} ( \dot{x} - 2 {\dot{x}}_{max} ⌊ \frac{\dot{x}}{2 {\dot{x}}_{max}} ⌉ ) = {( - 1 )}^{⌊ \frac{\dot{x}}{2 {\dot{x}}_{max}} ⌉} ( \dot{x} - 2 {\dot{x}}_{max} ⌊ \frac{\dot{x}}{2 {\dot{x}}_{max}} ⌉ ) g ( \dot{x} ) . \qquad \begin{matrix}( Equation 48 ) \\ \begin{matrix}\begin{matrix}\begin{matrix}\begin{matrix}\begin{matrix}( Equation 49 ) \\ \end{matrix} \\ \end{matrix} \\ ( Equation 50 )\end{matrix} \\ \end{matrix} \\ \begin{matrix}\begin{matrix}\begin{matrix}\begin{matrix}( Equation 51 ) \\ \end{matrix} \\ ( Equation 52 )\end{matrix} \\ \end{matrix} \\ ( Equation 53 )\end{matrix}\end{matrix}\end{matrix}$$

Remark 1. For applications of interest, a maximum platform speed and acceleration of the underwater vehicle is about 2 m/s and 0.3 m/s², respectively. The parameter α in the above motion models determines the level of acceleration and is chosen such that the standard deviation of αB(Tᵢ) is a third of 0.3Tᵢ, e.g., α=0.1\sqrt{Tᵢ}. Further choose \dot{x}ₘₐₓ=5 m/s.

The integrated reflected Brownian motion (IRBM) model ξ(t) defined in Definition 3 is no longer an independent increment process but its sample paths are continuous and it is a Feller process. This property may exploit the strong Markov property that follows from it.

Definition 4. (Markov Process) Let (Ω, [symbol] , P) be a probability space and let (S, [symbol] ) be a measurable space. The S-valued stochastic process ξ=(ξ(t), t∈ [symbol] _{≧0}) with natural filtration ( [symbol] ₜ,t∈ [symbol] _{≧0}) is said to be a strong Markov process, if for each A∈, s>0 and any stopping time τ,

P(ξ(τ+s)∈A| [symbol] _{τ})=P(ξ(τ+s)∈A|ξ(τ)) (Equation 54)

where

[symbol]

_{τ}={A∈ [symbol] :A∩{τ≦t}∈ [symbol] ₜ for all t>0} (Equation 55)

is the sigma algebra at the stopping time τ. If Equation 54 only holds for the trivial stopping times τ=t for any t>0, then the process is just called a Markov process. The Markov transition kernel μ_{t,t+s}(ξ0, A): [symbol] ≧0× [symbol] ≧0×S× [symbol] )>[0, 1] is a probability measure given any initial state ξ₀∈S and any t, s>0 and further:

μ_{t,t+s}(ξ(t),A)=P(ξ(t+s)∈A|ξ(t)) (Equation 56)

for any A∈ [symbol] and any t, s>0. A Markov process is homogeneous if for any initial state ξ₀∈S, any A∈ [symbol] and any t, s>0

μ_{t,t+s}(ξ₀,A)=μ_{0,s}(ξ₀,A) (Equation 57)

For homogeneous Markov processes, use the notation

P_{ξ0}(ξ(s)∈A≡μ_{0,s}(ξ₀,A). (Equation 58)

When the expected value of some random variable G is computed with respect to this probability measure, write [symbol] ξ₀[G].

Definition 5. (Feller Process) Let ξ=(ξ(t), t∈ [symbol] _{≧0}) be a homogeneous Markov process as defined in Definition 4. Then this process is called a Feller process, when, for all initial states ξ0:

1. for any t≧0, any event A∈ [symbol] and any sequence of states ξₙ∈S,

$${lim}_{n \to ∞} {ξ}_{n} = {ξ}_{0}$$

implies

$${lim}_{n \to ∞} {P}_{{ξ}_{n}} ( ξ ( t ) ∈ A ) = {P}_{ξ0} ( ξ ( t ) ∈ A )$$

2. for any

$$ε > 0 , {lim}_{t \to 0} P ( ‖ ξ ( t ) - {ξ}_{0} ‖ > ε \vert ξ ( 0 ) = {ξ}_{0} ) = 0.$$

Theorem 2. The bidimensional random process ξ(t) from Definition 3 is a Feller process.

Proof. The sample paths of the process ξ(t) are continuous and hence Property 2 in

Definition 5 holds. The process ξ(t) is a homogeneous Markov process and Property 1 in Definition 5 holds as well. Let [symbol] ₜ^{x} and [symbol] ₜ^{\dot{x}} be the natural filtrations of the processes x(t) and \dot{x}(t), respectively.

Establish from the definition of the function g(\dot{x}) in Equation 44 that

αB(t)+\dot{x}₀=g(αB(t)+\dot{x}₀)(−1)ⁿ+2\dot{x}ₘₐₓn (Equation 59)

where abbreviate the notation n(αB(t)+\dot{x}₀) by n.

Further, note that

$$\begin{matrix}\dot{x} ( t + τ ) = g ( α B ( t + τ ) + {\dot{x}}_{0} ) ( Equation 60 ) \\ = g ( α ( B ( t + τ ) - B ( t ) ) + α B ( t ) + {\dot{x}}_{0} ) ( Equation 61 ) \\ = g ( α ( B ( t + τ ) - B ( t ) ) + g ( α B ( t ) + {\dot{x}}_{0} ) {( - 1 )}^{n} + 2 {\dot{x}}_{max} n ) ( Equation 62 ) \\ = g ( {( - 1 )}^{n} ( α {B}^{′} ( τ ) g ( α B ( t ) + {\dot{x}}_{0} ) ) + 2 {\dot{x}}_{max} n ) ( Equation 63 ) \\ = g ( α {B}^{′} ( τ ) + g ( α B ( t ) + {\dot{x}}_{0} ) ) ( Equation 64 ) \\ = g ( α {B}^{′} ( τ ) + \dot{x} ( t ) ) . ( Equation 65 )\end{matrix}$$

Equation 62 follows from Equation 59. Equation 64 follows from Lemma 1. The weighted difference B′(τ)=(−1)n(B(t+τ)B(t)) is itself a Brownian motion and independent of [symbol] ₜ^{x} and [symbol] ₜ^{\dot{x}}

Next, take a look at the conditional moment-generating function of the bidimensional process ξ(t).

$$\begin{matrix} {𝔼}_{x 0 , {\dot{x}}_{0}} [ {e}^{ux ( t + τ ) + v \dot{x} ( t + τ )} \vert {ℱ}_{t}^{x} , {ℱ}_{t}^{\dot{x}} ] = & ( Equation 66 ) \\ {𝔼}_{{x}_{0} , {\dot{x}}_{0}} [ {e}^{u ( x ( t ) + {\int }_{0}^{τ} \dot{x} ( t + τ ) d τ ) + v \dot{x} ( t + τ )} \vert {ℱ}_{t}^{x} , {ℱ}_{t}^{\dot{x}} ] = & ( Equation 67 ) \\ {𝔼}_{{x}_{0} , {\dot{x}}_{0}} [ {e}^{u ( x ( t ) + {\int }_{0}^{τ} ℊ ( α {B}^{′} ( τ ) + \dot{x} ( t ) ) d τ ) + v ℊ ( α {B}^{′} ( τ ) + \dot{x} ( t ) )} \vert {ℱ}_{t}^{x} , {ℱ}_{t}^{\dot{x}} ] = & ( Equation 68 ) \\ {𝔼}_{{x}_{0} , {\dot{x}}_{0}} [ {e}^{u ( x ( t ) + {\int }_{0}^{τ} ℊ ( α {B}^{′} ( τ ) + \dot{x} ( t ) ) d τ ) + v ℊ ( α {B}^{′} ( τ ) + \dot{x} ( t ) )} \vert x ( t ) , \dot{x} ( t ) ] = & ( Equation 69 ) \\ {𝔼}_{x ( t ) , \dot{x} ( t )} [ {e}^{u ( x ( 0 ) + {\int }_{0}^{τ} ℊ ( α B ( τ ) + \dot{x} ( 0 ) ) d τ ) + v ℊ ( α B ( τ ) + \dot{x} ( 0 ) )} ] = & ( Equation 70 ) \\ {𝔼}_{x ( t ) , \dot{x} ( t )} [ {e}^{ux ( τ ) + v \dot{x} ( τ )} ] & ( Equation 71 )\end{matrix}$$

Equation 68 follows from Equation 65. Equation 69 follows from the Markov property of Brownian motion. Equation 71 follows from the fundamental theorem of calculus and Equation 43. So ξ(t) is a homogeneous Markov process. Now assume there are two sequences xₙ: [symbol] ₊→ [symbol] and \dot{x}ₘ:Z₊→ [symbol] such that

$${lim}_{n \to ∞} {x}_{n} = {x}_{0} and {lim}_{m \to ∞} {\dot{x}}_{n} = {\dot{x}}_{0} .$$

### Then

$$\begin{matrix} {lim}_{n , m \to ∞} {𝔼}_{{x}_{n} , {\dot{x}}_{m}} [ {e}^{ux ( τ ) + v \dot{x} ( τ )} ] = & ( Equation 72 ) \\ {lim}_{n , m \to ∞} 𝔼 [ {e}^{u ( {x}_{n} + {\int }_{0}^{τ} ℊ ( α B ( τ ) + {\dot{x}}_{m} ) d τ ) + v ℊ ( α B ( τ ) + {\dot{x}}_{m} )} ] = & ( Equation 73 ) \\ 𝔼 [ {e}^{u ( {lim}_{n \to ∞} {x}_{n} + {\int }_{0}^{τ} ℊ ( α B ( τ ) + {lim}_{m \to ∞} {\dot{x}}_{m} ) d τ ) + v ℊ ( α B ( τ ) + {lim}_{m \to ∞} {\dot{x}}_{m} )} ] = & ( Equation 74 ) \\ 𝔼 [ {e}^{u ( {x}_{0} + {\int }_{0}^{τ} ℊ ( α B ( τ ) + {\dot{x}}_{0} ) d τ ) + v ℊ ( α B ( τ ) + {\dot{x}}_{0} )} ] . & ( Equation 75 )\end{matrix}$$

Equation 74 follows from the dominated convergence theorem. Convergence of the moment-generating function implies convergence of the corresponding distribution and hence Property 1 in Definition 5 holds as well.

Now assuming that the motion model for the transmitter and receiver is as defined in Definition 3, transmitter speed is bounded and there is a unique solution te to the implicit equation

$$t - {t}_{e} - \frac{\vert {x}_{l} ( t ) - {x}_{i} ( {t}_{e} ) \vert}{c} = 0 \qquad ( Equation 76 )$$

for any t by Theorem 1. For the sequence te[n], the solutions of the implicit Equation 76 for t=nTᵢ, is strictly increasing in n.

Theorem 3. Assume both transmitter and receiver motion, ξᵢ(t) and ξₗ(t), are as determined in Definition 3. If tₑ[n] denotes the solution of the implicit Equation 76 for t=nTᵢ, then

tₑ[n+1]>tₑ[n],∀n. (Equation 77)

Further,

$${T}_{i} ( \frac{1 + \frac{{\dot{x}}_{max}}{c}}{1 - \frac{{\dot{x}}_{max}}{c}} ) \geq \vert {t}_{e} [ n + 1 ) - {t}_{e} [ n ] \vert \geq {T}_{i} ( \frac{1 - \frac{{\dot{x}}_{max}}{c}}{1 + \frac{{\dot{x}}_{max}}{c}} ) \qquad ( Equation 78 )$$

Proof. Evaluating the implicit Equation 76 for t=nTᵢ and t=(n+1)Tᵢ gives

$$\begin{matrix} {nT}_{i} - {t}_{e} [ n ] - \frac{\vert {x}_{l} ( {nT}_{i} - {x}_{i} ( {t}_{e} [ n ] ) \vert}{c} = 0 & ( Equation 79 ) \\ and & \\ ( n + 1 ) {T}_{i} - {t}_{e} [ n + 1 ] - \frac{\vert {x}_{l} ( ( n + 1 ) {T}_{i )} - {x}_{i} ( {t}_{e} [ n + 1 ] ) \vert}{c} = 0 & ( Equation 80 )\end{matrix}$$

The theorem follows from iterated application of the triangle inequality. By a suitable zero-sum expansion,

|xₗ((n+1)Tᵢ)−xᵢ(tₑ[n+1])|=|xₗ((n+1)Tᵢ)−xₗ(nTᵢ)+xᵢ(nTᵢ)−xᵢ(tₑ[n])+xᵢ(tₑ[n])−xᵢ(tₑ[n+1])|≦|xₗ((n+1)Tᵢ)−xₗ(nTᵢ)|+|xₗ(nTᵢ)−xᵢ(tₑ[n])|+|xᵢ(tₑ[n])−xᵢ(tₑ[n+1])| (Equation 81)

Subtracting Equation 80 from Equation 79, yields

$$\begin{matrix} - {T}_{i} + ( {t}_{e} [ n + 1 ] - {t}_{e} [ n ] ) = & ( Equation 82 ) \\ \frac{1}{c} ( \vert {x}_{l} ( {nT}_{i} ) - {x}_{i} ( {t}_{e} [ n ] ) \vert - \vert {x}_{l} ( ( n + 1 ) {T}_{i} ) - {x}_{i} ( {t}_{e} [ n + 1 ] ) \vert ) \geq & ( Equation 83 ) \\ - \frac{1}{c} ( \vert {x}_{i} ( {t}_{e} [ n + 1 ] ) - {x}_{i} ( {t}_{e} [ n ] ) \vert + \vert {x}_{l} ( ( n + 1 ) {T}_{i} ) - {x}_{l} ( {nT}_{i} ) \vert ) \geq & ( Equation 84 ) \\ - \frac{1}{c } ( {\dot{x}}_{max} \vert {t}_{e} [ n + 1 ] - {t}_{e} [ n ] \vert + {\dot{x}}_{max} {T}_{i} ) & ( Equation 85 )\end{matrix}$$

The first inequality follows from Equation 81. The second inequality follows from the fact that the involved motion processes have bounded speed. Hence write

$${t}_{e} [ n + 1 ] - {t}_{e} [ n ] \geq {T}_{i} - \frac{{\dot{x}}_{max}}{c} ( \vert {t}_{e} [ n + 1 ] - {t}_{e} [ n ] \vert + {T}_{i} ) \qquad ( Equation 86 )$$

and conclude

$$\begin{matrix}( {t}_{e} [ n + 1 ] - {t}_{e} [ n ] ) \underbrace{( 1 + sgn ( {t}_{e} [ n + 1 ] - {t}_{e} [ n ] ) \frac{{\dot{x}}_{max}}{c} )} > 0 \geq {T}_{i} ( 1 - \frac{{\dot{x}}_{max}}{c} ) > 0 & ( Equation 87 ) \\ and & \\ \vert {t}_{e} [ n + 1 ] - {t}_{e} [ n ] \vert \geq {T}_{i} ( \frac{1 - \frac{{\dot{x}}_{max}}{c}}{1 + \frac{{\dot{x}}_{max}}{c}} ) & ( Equation 88 )\end{matrix}$$

This proves the inequality of Equation 77 and the right-hand side inequality in Equation 78. If instead of expanding the argument of the right-hand side norm of Equation 83, the argument of the left-hand side norm of Equation 83 is expanded, get the inequality

$${t}_{e} [ n + 1 ] - {t}_{e} [ n ] \leq {T}_{i} + \frac{{\dot{x}}_{max}}{c} ( \vert {t}_{e} [ n + 1 ] - {t}_{e} [ n + 1 ] - {t}_{e} [ n ] \vert + {T}_{i} \qquad ( Equation 89 )$$

and conclude

$$\vert {t}_{e} [ n + 1 ] - {t}_{e} [ n ] \vert \leq {T}_{i} ( \frac{1 + \frac{{\dot{x}}_{max}}{c}}{1 - \frac{{\dot{x}}_{max}}{c}} ) \qquad ( Equation 90 )$$

The fact that the emission times tₑ[n] are strictly increasing allows to prove that ξᵢ(tₑ[n]) is Markov.

Theorem 4. Assume both transmitter and receiver motion, ξᵢ(t) and ξₗ(t), are as determined in Definition 3, but that the receiver motion ξₗ(t) is given at the times nTᵢ. Also, let the time tₑ[n] denote the solution of the implicit Equation 76 for t=nTᵢ. Then the sequence ξᵢ(tₑ[n]) is Markov, e.g., for any A∈B( [symbol] ²),

P_{ξ}_{ᵢ₍₀₎}(ξᵢ(tₑ[n+1])∈A|ξᵢ(tₑ[k−1]),k≦n)=Pξᵢ₍₀₎(ξᵢ(tₑ[n+1])∈A|ξᵢ(tₑ[n])) (Equation 91)

Further,

P_{ξ}_{ᵢ₍₀₎}(ξᵢ(tₑ[n+1])∈A|ξᵢ(tₑ[n]))=P_{ξ}_{ᵢ₍₀₎}(ξᵢ(t_{e[n]})(ξᵢ(δtₑ)∈A) (Equation 92)

where

$$δ {t}_{e} = inf \{ δ {t}_{e} \text{:} {T}_{i} - δ {t}_{e} = \frac{1}{c} ( \vert {x}_{l} ( ( n + 1 ) {T}_{i} ) - {x}_{i} ( 0 ) {\int }_{0}^{δ {t}_{e}} {\dot{x}}_{i} ( τ ) d τ \vert … - \vert {x}_{l} ( {nT}_{i} ) - {x}_{i} ( 0 ) \vert ) \} \qquad ( Equation 93 )$$

Proof. The sequence of σ-algebras [symbol] ₜ^{ξ}^{ᵢ}=σ{ξᵢ(τ)⁻¹( [symbol] ( [symbol] ²)),0≦τ≦t} is the natural filtration of the process ξᵢ(t). Let s and τ be some non-negative real numbers. The emission times tₑ[n] are stopping times and

$${ℱ}_{{t}_{e} [ n ] + 2}^{{ξ}_{i}}$$

is the stopping time σ-algebra for the stopping time tₑ[n]+s. Since ξᵢ(t) is a time-homogeneous strong Markov process, by Theorem 2, for any s, τ≧0 and A∈ [symbol] ( [symbol] ²) that

$$\begin{matrix}{P}_{ξ i ( 0 )} ( {ξ}_{i} ( {t}_{e} [ n ] + s + τ ) ∈ A \vert {ℱ}_{{t}_{e} [ n ] + s}^{{ξ}_{i}} ) = {P}_{ξ i ( 0 )} ( {ξ}_{i} ( {t}_{e} [ n ] + s + τ ) ∈ A \vert {ξ}_{i} ( {t}_{e} [ n ] + s ) ) = & ( Equation 94 ) \\ {P}_{{ξ}_{i} ( {t}_{e} [ n ] + s )} ( {ξ}_{i} ( τ ) ∈ A ) & ( Equation 95 )\end{matrix}$$

For any two σ-algebras [symbol] and [symbol] of subsets of Ω, σ{ [symbol] , [symbol] } denotes the smallest σ-algebra that contains both [symbol] and [symbol] . Determine

$${\breve{ℱ}}_{{t}_{e} [ n ] + s}^{{ξ}_{i}} = σ \{ ( {{ξ}_{i} ( {t}_{e} [ n ] + γ )}^{- 1} ( ℬ ( {ℝ}^{2} ) ) , 0 \leq γ \leq s ) , ( {{ξ}_{i} ( {t}_{e} ( ( k - 1 ) {T}_{i} ) )}^{- 1} ( ℬ ( {ℝ}^{2} ) ) , k \leq n ) \} \qquad ( Equation 96 )$$

The stopping times tₑ[n] form a strictly increasing sequence in n by Theorem 3 and hence

$${\breve{ℱ}}_{{t}_{e} [ n ] + s}^{{ξ}_{i}} ⋐ {ℱ}_{{t}_{e} [ n ] + s}^{{ξ}_{i}} \qquad ( Equation 97 )$$

By the tower property of conditional expectation and Equations 94, 95 and 97, for any A∈ [symbol] ( [symbol] ²),

$$\begin{matrix}{P}_{{ξ}_{i} ( 0 )} ( {ξ}_{i} ( {t}_{e} [ n ] + s + τ ) ∈ A \vert {\breve{ℱ}}_{{t}_{e} [ n ] + s}^{{ξ}_{i}} ) = {P}_{{ξ}_{i} ( 0 )} ( {ξ}_{i} ( {t}_{e} [ n ] + s + τ ) ∈ A \vert {ξ}_{i} ( {t}_{e} [ n ] + s ) ) = & ( Equation 98 ) \\ {P}_{{ξ}_{i} ( {t}_{e} [ n ] + s )} ( {ξ}_{i} ( τ ) ∈ A ) & ( Equation 99 )\end{matrix}$$

So the process ξᵢ(t) renews itself after any stopping time tₑ[n].

Let δtₑ[n+1]=tₑ[n+1]−tₑ[n]. By the definition of the emission times tₑ[n],

$$δ {t}_{e} [ n + 1 ] = inf \{ δ {t}_{e} \text{:} {T}_{i} - δ {t}_{3} = … \frac{1}{c} ( \vert {x}_{l} ( ( n + 1 ) {T}_{i} ) - {x}_{i} ( {t}_{e} [ n ] + δ {t}_{e} ) \vert - \vert {x}_{l} ( {nT}_{i} ) - {x}_{i} ( {t}_{e} [ n ] ) \vert ) \} \qquad ( Equation 100 )$$

or equivalently

$$δ {t}_{e} [ n + 1 ] = inf \{ δ {t}_{e} \text{:} {T}_{i} - δ {t}_{e} = … \frac{1}{c} ( \vert {x}_{l} ( ( n + 1 {T}_{i} ) - {x}_{i} ( {t}_{e} [ n ] ) - {\int }_{0}^{δ {t}_{e}} {\dot{x}}_{i} ( {t}_{e} [ n ] + τ ) d τ \vert … - \vert {x}_{l} ( {nT}_{i} ) - {x}_{i} ( {t}_{e} [ n ] ) \vert ) \} \qquad ( Equation 101 )$$

Note that δtₑ[n+1] is independent of

$${ℱ}_{{t}_{e} [ n ]}^{{ξ}_{i}}$$

given ξᵢ(tₑ[n]) and hence

$$\begin{matrix}{P}_{{ξ}_{i} ( 0 )} ( {ξ}_{i} ( {t}_{e} [ n ] + δ {t}_{e} [ n + 1 ] ) ∈ A \vert {ξ}_{i} ( {t}_{e} ( ( k - 1 ) {T}_{i} ) ) , k \leq n ) = {P}_{{ξ}_{i} ( 0 )} ( {ξ}_{i} ( {t}_{e} [ n ] + δ {t}_{e} [ n + 1 ] ) ∈ A \vert {ξ}_{i} ( {t}_{e} [ n ] ) ) = & ( Equation 102 ) \\ {P}_{{ξ}_{i} ( {t}_{e} [ n ] )} ( {ξ}_{i} ( δ {t}_{e} ) ∈ A ) & ( Equation 103 )\end{matrix}$$

where δte is as determined in Equation 93.

There may not be an exact solution to the kernel P_{ξ}_{ᵢ}₍ₜ_{ₑ}_{[n])} (ξᵢ(δtₑ)∈A) from the previous theorem, but there is a good approximation.

Theorem 5. Assume both transmitter and receiver motion, ξᵢ(t) and ξₗ (t), are as determined in Definition 3, but that the receiver motion ξₗ (t) is given at the times nTᵢ. Further assume that the motion ξᵢ′(t) is as determined in Definition 2. The value ξᵢ(0) is given, it is the initial condition for the motion processes ξᵢ(t) and ξᵢ′(t)) and it is such that

|xₗ((n+1)Tᵢ)−xᵢ(0)|>\dot{x}ₘₐₓδtₘₐₓ (Equation 104)

where

$$δ {t}_{max} ≡ {T}_{i} ( \frac{1 + \frac{{\dot{x}}_{max}}{c}}{1 - \frac{{\dot{x}}_{max}}{c}} ) . \qquad ( Equation 105 )$$

Then, for any A∈ [symbol] ( [symbol] ²),

|P_{ξ}_{ᵢ}₍₀₎(ξᵢ(δtₑ[n+1])∈A)−P_{ξ}_{ᵢ}₍₀₎(ξᵢ′(δtₑ′[n+1])∈A)|≦2erfc(η)−erfc(3η) (Equation 106)

where

$$\begin{matrix}δ {t}_{e} [ n + 1 ] = inf \{ δ {t}_{e} \text{:} {T}_{i} - δ {t}_{e} = \frac{1}{c} ( \vert {x}_{l} ( ( n + 1 ) {T}_{i} ) - {x}_{i} ( 0 ) {\int }_{0}^{δ {t}_{e}} {\dot{x}}_{i} ( τ ) d τ … - \vert {x}_{l} ( {nT}_{i} ) - {x}_{i} ( 0 ) \vert ) \} & ( Equation 107 ) \\ δ {t}_{e}^{′} [ n + 1 ] = inf \{ δ {t}_{e}^{′} \text{:} {T}_{i} - δ {t}_{e}^{′} = \frac{1}{c} ( \vert {x}_{l} ( ( n + 1 ) {T}_{i} ) - {x}_{i}^{′ } ( 0 ) \vert … - sgn ( {x}_{l} ( ( n + 1 ) {T}_{i} ) - {x}_{i}^{′} ( 0 ) ) {\int }_{0}^{δ {t}_{e}^{′}} {\dot{x}}_{i}^{′} ( τ ) d τ - \vert {x}_{l} ( {nT}_{i} ) - {x}_{i}^{′} ( 0 ) \vert ) \} & ( Equation 108 ) \\ and & \\ η = \frac{{\dot{x}}_{max} - \vert {\dot{x}}_{i} ( 0 ) \vert}{α \sqrt{2 δ {t}_{max}}} . & ( Equation 109 )\end{matrix}$$

Proof. For all δtₑ≦δtₘₐₓ, Inequality of Equation 103 ensures

$$\vert {\int }_{0}^{δ {t}_{e}} {\dot{x}}_{i} ( τ ) d τ \vert \leq {\dot{x}}_{max} δ {t}_{max} < \vert {x}_{l} ( ( n + 1 ) {T}_{i} ) - {x}_{i} ( 0 ) \vert \qquad ( Equation 110 )$$

and hence

$$\vert {x}_{l} ( ( n + 1 ) {T}_{i} ) - {x}_{i} ( 0 ) - {\int }_{0}^{δ {t}_{e}} {\dot{x}}_{i} ( τ ) d τ \vert = \vert {x}_{l} ( ( n = 1 ) {T}_{i} ) - {x}_{i} ( 0 ) \vert - sgn ( {x}_{l} ( ( n + 1 ) {T}_{i} ) - {x}_{i} ( 0 ) ) {\int }_{0}^{δ {t}_{e}} {\dot{x}}_{i} ( τ ) d τ \vert \qquad ( Equation 111 )$$

Note that by Theorem 3 the inequality δtₑ[n+1]≦δtₘₐₓ holds almost surely.

Thus write

$$δ {t}_{e} [ n + 1 ] = inf \{ δ {t}_{e} \text{:} {T}_{i} - δ {t}_{e} = \frac{1}{c} ( \vert {x}_{l} ( ( n + 1 ) {T}_{i} ) - {x}_{i} ( 0 ) \vert … - sgn ( {x}_{l} ( ( n + 1 ) {T}_{i} ) - {x}_{i} ( 0 ) ) {\int }_{0}^{δ {t}_{e}} {\dot{x}}_{i} ( τ ) d τ - \vert {x}_{l} ( {nT}_{i} ) - {x}_{i} ( 0 ) \vert \} \qquad ( Equation 112 )$$

By the law of total probability,

P_{ξ}_{ᵢ}₍₀₎(ξᵢ(δtₑ[n+1])∈A)=P_{ξ}_{ᵢ}₍₀₎(ξᵢ(δtₑ[n+1])∈A}∩{|\dot{x}ᵢ(δt)|<\dot{x}ₘₐₓ,0≦δt≦δtₘₐₓ})+ . . . +P_{ξ}_{ᵢ}₍₀₎(ξᵢ(δₜₑ[n+1])∈A}∩{|\dot{x}ᵢ(δt)|<\dot{x}ₘₐₓ,0≦δt≦δtₘₐₓ}^{C}) (Equation 113)

By Definition 2 and 3 and Equation 111,

P_{ξ}_{ᵢ}₍₀₎({ξᵢ(δtₑ[n+1])∈A}∩{|\dot{x}ᵢ(δt)|<\dot{x}ₘₐₓ,0≦δt≦δtₘₐₓ})=P_{ξ}_{ᵢ}₍₀₎(ξ′ᵢ(δt′ₑ[n+1])∈A}∩{|\dot{x}ᵢ′(δt)|<\dot{x}ₘₐₓ,0≦δt≦δtₘₐₓ}), (Equation 114)

because given {|\dot{x}ᵢ (δt)|<\dot{x}ₘₐₓ, 0≦δt≦δtₘₐₓ}, the integrated Brownian motion model and the integrated reflected Brownian motion model coincide. Further by monotonicity

0≦P_{ξ}_{ᵢ}₍₀₎({ξᵢ(δtₑ[n+1])∈A}∩{|\dot{x}ᵢ(δt)|<\dot{x}ₘₐₓ,0≦δt≦δtₘₐₓ}^{C}) (Equation 115)

≦P_{ξ}_{ᵢ}₍₀₎({|\dot{x}ᵢ(δt)|<\dot{x}ₘₐₓ,0<δt≦δtₘₐₓ}^{C}) (Equation 116)

And by the Fréchet inequalities,

max(0,P_{ξ}_{ᵢ}₍₀₎(ξ′ᵢ(δt′ₑ[n+1])∈A)+P_{ξ}_{ᵢ}₍₀₎(|\dot{x}′ᵢ(δt)|<\dot{x}ₘₐₓ,0≦δt≦δtₘₐₓ)−1)≦P_{ξ}_{ᵢ}₍₀₎({ξ′ᵢ(δt′ₑ[n+1])∈A}∩{|\dot{x}′ᵢ(δt)|<\dot{x}ₘₐₓ,0≦δt≦δtₘₐₓ}) (Equation 117)

≦P_{ξ}_{ᵢ}₍₀₎(ξ′ᵢ(δt′ₑ[n+1])∈A) (Equation 118)

Conclude

$$\begin{matrix}\vert {P}_{{ξ}_{i} ( 0 )} ( {ξ}_{i} ( δ {t}_{e} [ n + 1 ] ) ∈ A ) - {P}_{{ξ}_{i} ( 0 )} ( {ξ}_{i}^{′} ( δ {t}_{e}^{′} [ n + 1 ] ) ∈ A ) \vert \leq {P}_{{ξ}_{i} ( 0 )} ( {\{ \vert {\dot{x}}_{i} ( δ t ) \vert < {\dot{x}}_{max} , 0 \leq δ t \leq {t}_{max} \}}^{C} ) \leq & ( Equation 119 ) \\ P ( {\{ \vert B ( δ t ) \vert < \frac{{\dot{x}}_{max} - \vert {\dot{x}}_{i ( 0 )} \vert}{α} , 0 \leq δ t \leq δ {t}_{max} \}}^{C} ) & ( Equation 120 )\end{matrix}$$

The following is an expression and an upper bound for the last term. Determine the square wave

$${s}_{{B}_{max}} ( b ) = {\sum }_{n = - ∞}^{∞} {( - 1 )}^{n} {1}_{\{ 2 n - 1 < b / {B}_{max} < 2 n + 1 \}} . \qquad ( Equation 121 )$$

for

$${B}_{max} = \frac{{\dot{x}}_{max} - \vert {\dot{x}}_{i} ( 0 ) \vert}{α} > 0.$$

This function is antisymmetric around Bₘₐₓ and −Bₘₐₓ. Let τ be the first time the Brownian motion B(t) hits either of those values. Then, by the reflection principle,

B′(t)=B(t)+1_{{t≧τ}}2(B(τ)−B(t)) (Equation 122)

is also a Brownian motion. It follows:

$${1}_{\{ τ > δ {t}_{max} \}} = \frac{1}{2} ( {s}_{{B}_{max}} ( B ( δ {t}_{max} ) ) + {s}_{{B}_{max}} ( {B}^{′} ( δ {t}_{max} ) ) ) \qquad ( Equation 123 )$$

Applying the expectation operator on both sides gives

$$\begin{matrix}P ( \vert B ( δ t ) \vert < {B}_{max} , 0 \leq δ t \leq δ {t}_{max} ) = [ ( {s}_{{B}_{max}} ( B ( δ {t}_{max} ) ) ] \\ = {\int }_{- ∞}^{∞} {s}_{{B}_{max}} ( b ) {p}_{δ {t}_{max}} ( b ) d b ( Equation 125 )\end{matrix} \qquad ( Equation 124 )$$

where p_{δt}_{ₘₐₓ} (b) is the density of the N (0, δtₘₐₓ) Gaussian distribution. This integral can easily be bounded by truncating the sum s_{B}_{ₘₐₓ}(b), because |s_{B}_{ₘₐₓ}(b)|=1 and the density p_{δt}_{ₘₐₓ}(b) is decreasing in |b|:

$$\begin{matrix}{\int }_{- ∞}^{∞} {S}_{{B}_{max}} ( b ) {p}_{δ {t}_{max}} ( b ) d b \geq {\int }_{- {B}_{max}}^{{B}_{max}} {p}_{δ {t}_{max}} ( b ) d b - 2 {\int }_{{B}_{max}}^{3 {B}_{max}} {p}_{δ {t}_{max}} ( b ) d b & ( Equation 126 ) \\ = 2 erf ( \frac{{B}_{max}}{\sqrt{2 δ {t}_{max}}} ) - erf ( \frac{3 {B}_{max}}{\sqrt{2 δ {t}_{max}}} ) & ( Equation 127 )\end{matrix}$$

And hence

$$\vert {P}_{{ξ}_{i} ( 0 )} ( {ξ}_{i} ( δ {t}_{e} [ n + 1 ] ) ∈ A ) - {P}_{{ξ}_{i} ( 0 )} ( {ξ}_{i}^{′} ( δ {t}_{e}^{′} [ n + 1 ] ) ∈ A ) \vert \leq 1 - 2 erf ( \frac{{B}_{max}}{\sqrt{2 δ {t}_{max}}} ) - erf ( \frac{3 {B}_{max}}{\sqrt{2 δ {t}_{max}}} ) \qquad ( Equation 128 )$$

For large real η, the following asymptotic expansion of the complementary error function exists:

$$erfc ( η ) = \frac{{e}^{- {η}^{2}}}{η \sqrt{π}} {\sum }_{n = 0}^{∞} {( - 1 )}^{n} \frac{( 2 n - 1 ) !!}{{( 2 {η}^{2} )}^{n}} \qquad ( Equation 129 )$$

The realistic values \dot{x}ₘₐₓ=5, Tᵢ=10⁻⁵, =2 and α=0.1\sqrt{Tᵢ}, yield

a η=2.1143×10⁶. The corresponding error

2erfc(η)−erfc(3η)<10⁻10¹² (Equation 130)

and is negligible.

The following is an expression for the approximate transition probability P_{ξ}_{ᵢ}₍₀₎(ξ′ᵢ(δt′ₑ[n+1])∈A) from the previous theorem.

Theorem 6. Assume the transmitter motion ξ′ᵢ(t) is as determined in Definition 2, the receiver motion ξl(t) is given at the times nTi and ξ′ᵢ(0) is the initial condition for the motion process ξ′ᵢ(t). Let

$$δ {t}_{e}^{′} [ n + 1 ] = inf \{ δ {t}_{e}^{′} \text{:} {T}_{i} - δ {t}_{e}^{′} = \frac{1}{c} ( \vert {x}_{l} ( ( n + 1 ) {T}_{i} ) - {x}_{i}^{′} ( 0 ) \vert … - sgn ( {x}_{l} ( ( n + 1 ) {T}_{i} ) - {x}_{i}^{′} ( 0 ) ) {\int }_{0}^{δ {t}_{e}^{′}} {x}_{i}^{′} ( τ ) d τ - \vert {x}_{l} ( {nT}_{i} ) - {x}_{i}^{′} ( 0 ) \vert ) \} \qquad ( Equation 131 )$$

Then

x′ᵢ(δt′ₑ[n+1])=x′ᵢ(0)+δt′ₑ[n+1]\dot{x}′ᵢ(0)−αsgn(xₗ((n+1)Tᵢ)−x′ᵢ(0))I′ (Equation 132)

with

$$\begin{matrix} {I}^{′} = - β - δ {t}_{e}^{′} [ n + 1 ] γ & ( Equation 133 ) \\ β = \frac{1}{α} ( - {cT}_{i} + \vert {x}_{l} ( ( n + 1 ) {T}_{i} ) - {x}_{i} ( 0 ) \vert - \vert {x}_{l} ( {nT}_{i} ) - {x}_{i} ( 0 ) \vert ) & ( Equation 134 ) \\ γ = \frac{1}{α} ( c - sgn ( {x}_{l} ( ( n + 1 ) {T}_{i} ) - {x}_{i} ( 0 ) ) {\dot{x}}_{i} ( 0 ) ) & ( Equation 135 )\end{matrix}$$

and

\dot{x}′ᵢ(δt′ₑ[n+1])=\dot{x}′ᵢ(0)−αsgn(xₗ((n+1)Tᵢ)−x′ᵢ(0))B′ (Equation 136)

The random variables δt′ₑ [n+1] and B′ have the joint distribution

P_{β,γ}(δt′ₑ[n+1]∈dt;B′∈dz)=|z|[pₜ(β,γ;0,z)−∫₀^{t}∫₀^{∞}m(s,−|z|,μ)pₜ₋ₛ(β,γ;0,−∈μ)dμds]1_{R}(z)dzdt (Equation 137)

where R=[0, ∞] if β<0, R=(−∞, 0] if β>0, ∈=sgn(−β), the function

$$\begin{matrix}m ( t , y , z ) = \frac{3 z}{π \sqrt{2 {t}^{2}}} {e}^{( - 2 / t ) ( {y}^{2} - \vert y \vert z + {z}^{2} )} ( {\int }_{0}^{4 \vert y \vert z / t} {e}^{- 3 θ / 2} \frac{ d θ}{\sqrt{πθ}} ) {1}_{[ 0 , ∞ ]} d z d t \\ and & ( Equation 138 ) \\ {p}_{t} ( u , v ; x , y ) = \frac{\sqrt{3}}{π {t}^{2}} exp [ - \frac{6}{{t}^{3}} {( u - x - ty )}^{2} + \frac{6}{{t}^{2}} ( u - x - ty ) ( v - y ) - \frac{2}{t} {( v - y )}^{2} ] & ( Equation 139 )\end{matrix}$$

Proof. First, manipulate the equation in the definition of the hitting time δtₑ[n+1] in the theorem statement. This equation reads

$${T}_{i} - δ {t}_{e}^{′} = \frac{1}{c} ( \vert {x}_{l} ( ( n + 1 ) {T}_{i} ) - {x}_{i}^{′} ( 0 ) \vert … - sgn ( {x}_{l} ( ( n + 1 ) {T}_{i} ) - {x}_{i}^{′} ( 0 ) ) {\int }_{0}^{δ {t}_{e}^{′}} {\dot{x}}_{i}^{′} ( τ ) d τ - \vert {x}_{l} ( {nT}_{i} ) - {x}_{i}^{′} ( 0 ) \vert ) \qquad ( Equation 140 )$$

Note that

\dot{x}′ᵢ(τ)=\dot{x}′ᵢ(0)+αB(τ) (Equation 141)

and that

B′(τ)=−sgn(xₗ((n+1)Tᵢ)−x′ᵢ(0))B(τ) (Equation 142)

is again a Brownian motion. Equation 140 is hence equivalent to

$$0 = β + δ {t}_{e} γ + {\int }_{0}^{δ {t}_{e}} {B}^{′} ( τ ) d τ \qquad ( Equation 143 )$$

and have

$$δ {t}_{e} [ n + 1 ] = inf \{ δ {t}_{e} \text{:} β = δ {t}_{e} γ + {\int }_{0}^{δ {t}_{e}} {B}^{′} ( τ ) d τ \} \qquad ( Equation 144 )$$

Determine the random variable B′=B′(δtₑ [n+1]). The joint distribution of the random variables δtₑ [n+1] and B′ is known. The function pₜ(u, v; x, y) in Equation 139 is the transition density of the bidimensional process (∫₀^{t} B′(τ)dτ, B′(t)).

Therefore, the above theorems show that the sampled bidimensional process (xᵢ(tₑ[n]), \dot{x}ᵢ (tₑ[n])) is Markov in n and Theorem 6 gives an excellent approximation of the transition kernel of this Markov chain.

Bayesian State Inference

On a high level, the above sections introduced a prior distribution on all relevant system states: the transmitted symbols (Equation 31), the channel gains (Equation 36), the receiver motion (Equation 37) and the transmitter motion (Theorem 4 and 6). Further, the likelihood functions are determined of the observable data given these states (Equation 34). Theoretically, this is sufficient to deduce the a posteriori distribution of the states and hence obtain estimates according to any given cost function. But inference may be found to be only tractable in some special cases, when abstaining from trying to jointly estimate all states, but instead assume that some of the states are known. The following is a case of a stationary transmitter.

Stationary Transmitter

Assume array i rests in the origin and transmits and array 1 is mobile and receives. If the transmit array has only one element, assuming an isotropic spreading model the generated acoustic field is spherically symmetric and the receiver cannot uniquely determine its position and orientation. In fact, the locus of possible positions is a sphere. However, if there are at least three elements on the receive array and the receiver has access to a compass and a tilt sensor, this symmetry can be broken. Accelerometers are inexpensive and can determine tilt reliably. The accuracy of magnetic compasses can be compromised by a submarine's shielding ferric hull, but gyro-compasses do not have this problem and are well suited for this task, because they rely on the effect of gyroscopic precession instead of the Earth's magnetic field. Measurements from inertial sensors can be included for state inference as explained below. For now assume that the transmitter has more than three elements and hence circumvent this problem. Further assume that there is no multi-path and that the transmitted signals are known.

Given these assumptions, the sampled output equations from Equation 34 specialize to

$${r}_{l , m} [ n ] = {\sum }_{j , k} {h}_{i , j ; l , m} [ n , k ] {e}^{2 π \sqrt{- 1} {fc}_{i} ( {t}_{i , j ; l , m} [ n ] - {nT}_{i} )} {s}_{i , j} ( {t}_{i , j ; l , m} [ n ] - {kT}_{i} ) + {v}_{l , m} [ n ] \qquad ( Equation 145 )$$

where ti,j;l,m[n] can now be solved for explicitly

$${t}_{i , j ; l , m} [ n ] = {nT}_{i} - \frac{‖ {x}_{l , m} ( {nT}_{i} ) - {x}_{i , j} ‖}{c} \qquad ( Equation 146 )$$

and the noise v_{l,m}[n] is i.i.d. Model the channel gains h_{i,j;l,m}[n, k] as described above and model the receiver position xₗ(nTᵢ) and orientation θₗ(nTᵢ) as described above. The signals s_{i,j} (t) are assumed to be known.

Equations 36 and 37 determine a linear state space system driven by Gaussian noise and Equations 145 determine non-linear output equations. Several inference methods have been developed for such systems. The extended Kalman filter (EKF) can linearize the equations around the current estimate in each step and then applies the Kalman filter equations. This algorithm can work with navigation systems and GPS, or other position determining device, to provide position information to the algorithm. When the state equations or the output equations are highly non-linear as in Equation 145, the EKF can, however, give poor performance.

The application of the Kalman filter to a nonlinear system includes the computation of the first two moments of the state vector and the observations. This can be viewed as specific case of a more general problem: The calculation of the statistics of a random vector after a nonlinear transformation. The unscented transformation attacks this problem with a deterministic sampling technique. It determines a set of points (called sigma points) that accurately capture the true mean and covariance of the sampled random vector. The nonlinear transformation is then applied on each of these points which results in samples of the transformed random vector and a new sample mean and covariance can be computed. It can be shown analytically that the resulting unscented Kalman filter (UKF) is superior to the EKF but has the same computational complexity. Developing the Taylor series expansions of the posterior mean and covariance shows that sigma points capture these moments accurately to the second order for any nonlinearity. For the EKF, only the accuracy of the first order terms can be guaranteed.

An UKF can be implemented for inference on the model presented here. In one example, a known signal (a 100 Hz wide pulse at a center frequency of 25 kHz) was played from a speaker and fed the UKF with the measurements from a moving microphone. For this simple one dimensional setup, it was verified that this approach yields position estimates with a precision of less than a millimeter.

Inertial sensors provide additional information about the trajectory to be tracked. Accelerometers, for example, provide noisy observations of the acceleration that the sensor experiences and gyroscopes measure experienced angular velocity. When using such sensors on the mobile receiver, the generated observations and measurements are taken into account by adding additional output equations to the state space system describing the position and orientation of the receiver array. This combination of sensory data is called sensor fusion. Measurements a_{l;k}[n] of the acceleration values x_{l;k}⁽²⁾(nTᵢ) can for example be incorporated by adding the output equations

a_{l;k}[n]=x_{l;k}⁽²⁾(nTᵢ)+uₖ[n], (Equation 147)

where uₖ[n] is assumed to be white Gaussian noise.

Ideally, not only track the receiver position and orientation, but also communicate data. As described above, broadband transmission signals s_{i,j} (t) can be used of the form

s_{i,j}(t)=Σ_{l∈[0:N]}s_{i,j}[l]p(t−lT). (148)

In order to communicate information from the transmitter to the receiver, assume some of the symbols s_{i,j} [l] to be unknown, i.i.d. random variables with a uniform distribution over the possible constellation points and then estimate those unknown symbols jointly with the channel attenuation and motion states. However, joint estimation of all these states may be difficult and hard to implement for several reasons.

The pulse p(t) should be band limited because as discussed above the channel is band limited. But in order for p(t) to have most of its energy in a finite band, the pulse length needs to be large and hence, for any time t, the value of s_{i,j} (t) depends on many symbols s_{i,j}[l]. The signals s_{i,j} (t) are sampled at the random times t_{i,j;l,m}[n]−kTᵢ in Equation 145 and

s_{i,j}(t_{i,j;l,m}[n]−kTᵢ)=Σ_{l∈[N]0}s_{i,j}[l]p(t_{i,j;l,m}[n]−kTᵢ−lT). (Equation 149)

The computational complexity of the EKF or the UKF is quadratic in the dimension of the state vector and both methods require that a state space model for the states to be estimated is available. The only state space system for the unknown symbols in the sequence, s_{i,j} [l], is a trivial one with very large dimensionality:

s_{i,j}[l]=s_{i,j}[l],∀j∈[K] and l∈Sᵤ (Equation 150)

where the set Sᵤ contains the indices of the unknown symbols. This would make the complexity of each EKF or UKF step quadratic in the size of Sᵤ, which is impractical. Another idea is run a particle filter on this high dimensional state space system and then to only update those indices in Sᵤ in each step, which are in the vicinity of └t_{i,j;l,m}[n]/Tᵢ−k┐. The following describes a low complexity deterministic approach for joint data and channel estimation.

Deterministic Inference

The systems and methods can facilitate reliable communication over the underwater acoustic channel and at the same time be computationally light enough to allow for an implementation on modern embedded computing platforms. Assume that array i is mobile and transmits while array 1 is stationary and receives. Array i is trivial and only carries one transducer. Array 1 carries K transducers. Account for multi-path effects but assume that the Doppler is the same on all paths. This is a good approximation when all phantom sources are near each other, as is the case in long range shallow water channel for example. Since the transmit array is assumed trivial, no index is needed to enumerate its elements. Without loss of generality assume the parameters i and 1 fixed. In what follows there is no ambiguity as to which of the two arrays are being referring to and hence the indices i and j are dropped for the sake of notational simplicity.

Send a signal s(t) of the form described above and choose the symbols s[l] from an q-ary QAM constellation. Some of these symbols are known and used for training. Some are unknown and used for data communication.

Under the above assumptions the demodulated received signals from Equation 33 simplify to

rₘ(t)=∫_{τ}^{t}hₘ(t,τ)e^{2π\sqrt{-1}f}^{_{C}}^{(t}^{ₘ}^{(t)-τ-t)}s(tₘ(t)−τ)dτ+vₘ(t) (Equation 151)

where m indexes the receiving transducers and the emission time tₘ(t) solves the implicit equation

$$t - {t}_{m} ( t ) = \frac{‖ {x}_{m} ( t ) - x ( {t}_{m} ( t ) ) ‖}{c} = 0. \qquad ( Equation 152 )$$

The sent signal s(t) has a bandwidth of 1/T and can hence represent the integral in Equation 150 as a sum:

rₘ(t)=Σₖh_{m;k}(t)e^{2π\sqrt{-1}f}^{_{C}}^{(t}^{ₘ}^{(t)-t)}s(tₘ(t)−kT)+vₘ(t) (Equation 153)

where

h_{m;k}(t)=Thₘ(t,kT)e^{-2π\sqrt{-1}f}^{_{C}}^{kT} (Equation 154)

is the demodulated and sampled kernel.

Determine the sequence of arrival times tₘ⁻¹ [n] as the solutions to the implicit equation

$${t}_{m}^{- 1} [ n ] - n T - \frac{‖ {x}_{m} ( {t}_{m}^{- 1} [ n ] ) - x ( n T ) ‖}{c} = 0. \qquad ( Equation 155 )$$

Abbreviate x(nT) by x[n] and the derivative of x(t) at time nT by \dot{x}[n]. Since the receiver was assumed stationary, solve for tₘ⁻¹ (nT) explicitly

$${t}_{m}^{- 1} [ n ] - n T + \frac{‖ {x}_{m} - x ( n T ) ‖}{c} . \qquad ( Equation 156 )$$

The arrival times tₘ⁻¹[n] are the inverse of the function tₘ(t) evaluated at the times nT. They specify when an hypothetical impulse sent from the transmitter at time nT, would arrive at the m-th receiving transducer.

If sample the signal from Equation 153 at t=tₘ⁻¹[n], then

$${r}_{m} ( {t}_{m}^{- 1} [ n ] ) = {\sum }_{k} {h}_{m ; k} ( {t}_{m}^{- 1} [ n ] ) {e}^{2 π \sqrt{- 1} {f}_{C} ( n T - {t}_{m}^{- 1} [ n ] )} s [ n - k ] + {v}_{m} ( {t}_{m}^{- 1} [ n ] ) \qquad ( Equation 157 )$$

And if further multiply both sides of this equation by e^{-2π\sqrt{-1}f}^{_{C}}^{(nT-t}^{ₘ}^{^{−1}}^{[n])}, then obtain

$${e}^{2 π \sqrt{- 1} {f}_{C} ( n T - {t}_{m}^{- 1} [ n ] )} {r}_{m} ( {t}_{m}^{- 1} [ n ] ) = {\sum }_{k} {h}_{m} [ n , k ] s [ n - k ] + {v}_{m} [ n ] \qquad ( Equation 158 )$$

where hₘ[n,k]=h_{m;k} (tₘ⁻¹[n]) and vₘ[n] is some noise sequence.

These equations motivate a direct equalization estimator for the symbols s[n] of the following form:

s[n]≈ŝn=Σ_{m,k}w[n,m,k]rₘ(tₘ⁻¹[n−k])e^{-2π\sqrt{-1}f}^{_{C}}^{((n-k)T-t}^{ₘ}^{^{−1}}^{[n-k])} (Equation 159)

where w[n, m, k] are the complex-valued equalizer weights. Assume that k ranges from −M_{A} to M_{C} for some positive integers M_{A} and M_{C} and that M=M_{A}+M_{C}+1. To reduce the number of parameters of this estimator, determine the function

$${t}_{m ; n , k}^{- 1} ( x [ n ] , \dot{x} [ n ] ) = ( n - k ) T + \frac{‖ {x}_{m} - x [ n ] + k T \dot{x} [ n ] ‖}{c} \qquad ( Equation 160 )$$

and substitute tₘ⁻¹ [n−k] by t_{m;n,k}⁻¹ (x[n], \dot{x}[n]) in Equation 159. The resulting estimator is \tilde{s}ₙ(θ[n]), where the parameter vector θ[n]∈ [symbol] ^{2MK+6} is such that its components θ_{z}[n] satisfy

$${θ}_{z} [ n ] = \{ \begin{matrix}Re ( w [ n , m , k - {M}_{A} ] ) ; & \begin{matrix}z = 2 kK + 2 m - 1 , \\ k ∈ [ 0 \text{:} M - 1 ] , m ∈ [ K ]\end{matrix} \\ Im ( w [ n , m , k - {M}_{A} ] ) ; & \begin{matrix}z = 2 kK + 2 m , \\ k ∈ [ 0 \text{:} M - 1 ] , m ∈ [ K ]\end{matrix} \\ {x}_{q} [ n ] ; & z = 2 MK + q , q ∈ [ 3 ] \\ {\dot{x}}_{q} [ n ] ; & 2 MK + 3 + q , q ∈ [ 3 ]\end{matrix} \qquad ( Equation 161 )$$

This notation formalizes that the equalizer weights w[n, m, k−M_{A}], k∈[0:M−1], m∈[K], the position x[n] and the velocity \dot{x}[n] are concatenated into one real-valued parameter vector, the vector θ[n]. The function \tilde{s}ₙ(θ) reads

$${\hat{s}}_{n} ( θ ) = {\sum }_{k ∈ [ 0 : M - 1 ] , m ∈ [ K ]} ( {θ}_{2 kK + 2 m - 1} + \sqrt{- 1} {θ}_{2 kK + 2 m} ) \cdot … {r}_{m} ( {t}_{m ; n , k - {M}_{A}}^{- 1} ( {θ}_{2 MK + [ 3 ]} , {θ}_{2 MK + 3 + [ 3 ]} ) ) \cdot … {e}^{- 2 π \sqrt{- 1} {f}_{C} ( ( n - k + {M}_{A} ) T - {t}_{m ; n , k - {M}_{A}}^{- 1} ( {θ}_{2 MK + [ 3 ] ,} {θ}_{2 MK + 3 + [ 3 ]} ) )} \qquad ( Equation 162 )$$

Choose the parameter vector θ[n] such that the following objective function is minimized:

$${L}_{N} = \frac{1}{2} {( θ [ 0 ] - \hat{θ} )}^{T} {C}^{- 1} ( θ [ 0 ] - \hat{θ} ) + {\sum }_{n = 0}^{N} {\vert s [ n ] - {\hat{s}}_{n} ( θ [ n ] ) \vert}^{2} {σ}_{s}^{- 2} + \frac{1}{2} {\sum }_{n = 0}^{N - 1} {( θ [ n + 1 ] - T θ [ n ] )}^{T} {Q}^{- 1} ( θ [ n + 1 ] - T θ [ n ] ) \qquad ( Equation 163 )$$

for some number of known training symbols s[n],n=0, . . . , N. The vector \hat{θ} is the initial guess about the parameter vector θ[0] and C is a covariance matrix specifying how much confidence in this guess. The scalar σₛ⁻² is a weighting factor and the matrix Q⁻¹ is a weighting matrix.

The matrix T is a transition matrix with Tθ[n] specifying what θ[n+1] likely looks like. Allow for some error (θ[n+1]−Tθ[n]) in this plant model. Choose a simple transition matrix T with components T_{z,u} such that

$${T}_{z , u} = \{ \begin{matrix}1 ; & z = u , u ∈ [ 2 MK + 6 ] \\ T ; & \begin{matrix}z = 2 MK + q , \\ u = 2 MK + 3 + q , q ∈ [ 3 ]\end{matrix} \\ 0 ; & otherwise\end{matrix} \qquad ( Equation 164 )$$

The 6×6 sub matrix on the bottom right of T is the transition matrix for the position x[n] and the velocity \hat{x}[n] according to the motion model presented above for d=2.

The extended Kalman filter is known to find an approximate solution to the least squares problem in Equation 163 when run on the state space system

θ[n+1]=Tθ[n]+vₙ₊₁ (Equation 165)

and the output equations

s[n]=\tilde{s}ₙ(θ[n])+vₙ (Equation 166)

for n≧0. The noise values vₙ are independent, mean-zero, circular symmetric complex Gaussian random variables with variance σₛ². Denote the estimate of θ[n+1] given the symbols {s[l], 1∈[0:n]} by \hat{θ}[n+1, n]. The initial state estimate \hat{θ}[0, −1] is a Gaussian random vector with mean \hat{θ} and covariance C. The random vectors vₙ are independent and mean-zero. Each vector vₙ is Gaussian with covariance Q. The covariance matrix Q is chosen such that its components Q_{z,u} satisfy

$${Q}_{z , u} = \{ \begin{matrix}{σ}_{w}^{2} ; & z = u , u ∈ [ 2 MK ] \\ {σ}_{a}^{2} \frac{{T}^{4}}{4} ; & z = u , u ∈ 2 MK + [ 3 ] \\ {σ}_{a}^{2} {T}^{2} ; & z = u , u ∈ 2 MK + 3 + [ 3 ] \\ {σ}_{a}^{2} \frac{{T}^{3}}{2} ; & \begin{matrix}z = 2 MK + q , \\ u = 2 MK + 3 + q , q ∈ [ 3 ]\end{matrix} \\ {σ}_{a}^{2} \frac{{T}^{3}}{2} ; & \begin{matrix}z = 2 MK + 3 + q , \\ u = 2 MK + q , q ∈ [ 3 ]\end{matrix} \\ 0 ; & otherwise\end{matrix} \qquad ( Equation 167 )$$

for some variances σ_{w}² and σₐ². The 6×6 sub matrix on the bottom right of Q is the covariance matrix for the position x[n] and the velocity \dot{x}[n] according to the motion model presented above for d=2. The 2M_{K}×2M_{K} sub matrix on the top left of Q is diagonal and hence renders the evolution of all equalizer weights independent. The equalizer weights are assumed to be independent of the position and velocity of the transmitter.

Perform a method akin to decision directed equalization to obtain estimates of the symbols s[n] that are unknown and used for communication. In total N+1 symbols s[n] are sent. Assume the first Npre symbols {s[l],lE[0:Nₚᵣₑ−1]} and also a fraction of the subsequent symbols to be known. Let the set Sᵤ⊂[0:N] contain the indices of the unknown symbols. First run the extended Kalman filter on the known first Npre symbols {s[l],l∈[0:Nₚᵣₑ−1]} and obtain \hat{θ}[Nₚᵣₑ,Nₚᵣₑ−1]. Now if Nₚᵣₑ∈Su, then find the point in the symbol constellation A that is closest to \tilde{s}ₙ(\hat{θ}[Nₚᵣₑ,Nₚᵣₑ−1]) and declare that point to be s[Nₚᵣₑ]. The operation of mapping a complex number to its nearest constellation point is called slicing. Now regardless whether Nₚᵣₑ∈Sᵤ, the symbol s[Nₚᵣₑ] is available. So the extended Kalman filter can be updated and the next prediction \hat{θ}[Nₚᵣₑ+1, Nₚᵣₑ]) can be computed. Now check again if Nₚᵣₑ+1 ∈Su and, if so, slice \tilde{s}ₙ (\hat{θ}[Nₚᵣₑ+1, Nₚᵣₑ]) and declare the slicer output to be the symbol s[Nₚ+1]. Iterate the Kalman update and prediction steps and the conditional slicing operation until the last symbol s[N] is reached. At a high level, the estimator ŝₙ(\hat{θ}) first resamples the received waveforms to undo any timing distortions and then filters the resampled signal to remove any frequency selectivity present in the channel. This estimator can be referred to as a resampling equalizer (RE). Algorithm 1 describes the operation of the equalizer in pseudocode. The function slice(•) performs the slicing operation. The extended Kalman filter uses the values of the partial derivatives

$$\frac{\partial {\hat{s}}_{n} ( θ )}{\partial θ}$$

evaluated at \hat{θ}[n, n−1], n∈[0:N]. Approximate those numerically as shown in Algorithm 2.

Of course, it is not guaranteed that the slicer actually recovers the original symbol each time but as long as it does so most of the time, the Kalman filter remains stable. The rate at which the slicer misses is called the symbol error rate (SER). Each of the unknown QAM symbols {s[l], 1 ∈Sᵤ} corresponds to a bit pattern. The receiver maps the sliced symbols back to their corresponding bit pattern and ideally the resulting bit sequence agrees with the bit sequence that was sent originally.

Data: The transition matrix T, the covariance matrices Q and C, the variance σₛ² and the initial estimate \hat{θ} are given. Further, the set Sᵤ⊂[0:N] and the values of s[n] for n∉Sᵤ, are given.

Result: The sequence of symbol estimates \tilde{s}ₙ, n∈[0, N], and the sequence of hard decisions \tilde{s}ₙ, n∈[0, N].

Algorithm 1: The operation of the resampling equalizer (RE).

% initialization:
P = C;
for n = [0 : N] do

| | |
|---|---|
| \| | ŝₙ = ŝₙ(\hat{θ}); |
| \| | if n ∈ Sᵤ then |
| \| | \| s̅ₙ = slice(ŝₙ); |
| \| | else |
| \| | \| s̅ₙ = s[n]; |
| \| | end |
| \| | compute g ∈ [symbol] ^{1×2MK+6}, the numerical approximation to the gradient |
| \| | $\frac{\partial {\hat{s}}_{n} ( θ )}{\partial θ} {\vert}_{\hat{θ}} ;$ |
| \| | % perform Kalman update step: |
| \| | e = s̅ₙ − ŝₙ; |
| \| | $S = [ Re ( g ) ; Im ( g ) ] {P [ Re ( g ) ; Im ( g ) ]}^{T} + \frac{1}{2} {σ}_{S}^{2} I ;$ |
| \| | K = P[Re(g); Im(g)]^{T} S⁻¹; |
| \| | \hat{θ} = \hat{θ} + K[Re(e); Im(e)]; |
| \| | P = (I − K[Re(g); Im(g)])P; |
| \| | % perform Kalman prediction step: |
| \| | \hat{θ} = T\hat{θ}; |
| \| | P = TPT^{T} + Q; |

End

In most cases, however, there will be bit errors and the rate at which these occur is called the bit error rate (BER). If the BER at the equalizer output is too high for a given application, channel coding can be used at the transmitter to reduce the BER at the expense of the rate the sequence of information bits is transmitted. Channel coding adds redundancy to the sequence of information bits that is to be communicated. The enlarged bit sequence is mapped to QAM symbols. These symbols are unknown at the receiver and call them information symbols. The equalizer may need training before any unknown symbols can be estimated, and hence add in some known QAM symbols into this stream of information symbols. The resulting sequence carries information symbols at the indices n∈Su and known symbols at the other indices.

Data: The state vector \hat{θ} is given. The constants ∈, δ>0 are some small real numbers.

$$\frac{\partial {\hat{s}}_{n} ( θ )}{\partial θ} {\vert}_{\hat{θ}} .$$

Result: The vector g∈ [symbol] ^{1×2MK+6} that approximates the gradient

$Algorithm 2 \text{:} Numerical approximation of \frac{\partial {\hat{s}}_{n} ( θ )}{\partial θ} {\vert}_{\hat{θ}} .$

% initialization:
g = 0_{1×2MK+6};
for k = [0: M − 1]do

| \| | | for m = [K]do | |
|---|---|---|---|
| \| | \| | | g_{2kK+2m-1} = rₘ(t_{m;n,k-M}_{_{A}}⁻¹(θ_{2MK+[3]}&, θ_{2MK+3+[3]})) · . . . |
| \| | \| | | ${e}^{- 2 π \sqrt{- 1} {f}_{C} ( ( n - k + {M}_{A} ) T - {t}_{m ; n , k - {M}_{A}}^{- 1} ( {θ}_{2 MK + [ 3 ]} , {θ}_{2 MK + 3 + [ 3 ]} ) )} ;$ |
| \| | | | g_{2kK+2m} = \sqrt{−1}g_{2kK+2m-1}; |

| | |
|---|---|
| \| | end |

end
\hat{θ}⁺ = \hat{θ};
for q = [3]do

| | |
|---|---|
| \| | \hat{θ}_{2MK+q}⁺ = \hat{θ}_{2MK+q}⁺^{^{+∈}}; |
| \| | g_{2MK+q} = (ŝₙ(\hat{θ}⁺) − ŝₙ(\hat{θ}))/∈; |
| \| | \hat{θ}_{2MK+q}⁺ = \hat{θ}_{2MK+q}; |
| \| | \hat{θ}_{2MK+3+q}⁺ = \hat{θ}_{2MK+3+q}⁺ +δ; |
| \| | g_{2MK+3+q} = (ŝₙ(\hat{θ}⁺) − ŝₙ(\hat{θ}))/δ; |
| \| | \hat{θ}_{2MK+3+q}⁺ = \hat{θ}_{2MK+3+q}; |

end

At the receiver the bit stream from the slicer output is fed into a channel decoder that uses the added redundancy to reduce the BER on the sequence of sent information bits. The amount of redundancy depends on the equalizer output BER and the maximal permissible BER on the sequence of information bits. BER performance can be improved significantly if the equalizer and the channel decoder collaborate. There is literature on the field of iterative equalization and decoding (also known as turbo equalization) that describes how this collaboration can be furnished. For these results to apply, the equalizer is capable of leveraging soft information from the decoder and further to produce soft output instead of sliced hard decisions. There are standard methods available to extend direct equalizers. When used in the setting of turbo equalization, refer to the equalizer as a turbo resampling equalizer (TRE).

Let x[n+1, n] and \dot{x}[n+1, n] denote the position estimate \hat{θ}_{2MK+[3]}[n+1, n] and the velocity estimate \hat{θ}_{2MK+3+[3]}[n+1, n], respectively. In some examples, it was found that, in order for the Kalman filter to converge, the initial estimates of the transmitter position x[0, 1] and velocity \dot{x}[0, 1] are accurate enough such that t_{m;0,0}⁻¹(x[0, −1], \dot{x}[0, −1]) deviates from t_{m;0,0}⁻¹(x[0], \dot{x}[0]) by at most about one symbol period T, for all m∈[K]. The trilateration method can be used to obtain estimates of x[0] and \dot{x}[0]. Transmit two chirps before any QAM symbols are sent and then measure when each of these two chirps arrives at the receive transducers. Trilateration computes two estimates of the transmitter position from these arrival time measurements—one estimate for each transmitted chirp. If it is assumed that the first chirp was sent at time t=t_{C1} and that the second chirp was sent at a later time t=t_{C2}, then this method obtains estimates of the positions x(t_{C1}) and x(t_{C2}). The difference quotient (x(t_{C2}) x(t_{C1}))/(t_{C2}−t_{C1}) gives the average velocity between the two times t=t_{C1} and t=t_{C2}. Set \dot{x}[0, 1] equal to this average velocity and further set x[0, −1]=x(t_{C2})−t_{C2}\dot{x}[0, −1].

For the derivation above, assume that the receiver array is stationary. If this assumption does not hold, still use the introduced equalizer for communication and accept that the states x[n] and \dot{x}[n] no longer correspond to the position and velocity of the transmitter with respect to a fixed cartesian frame of reference.

Experimental Results

The turbo resampling equalizer (TRE) demonstrated unprecedented communication performance in US Navy sponsored field tests and simulations. Some of the real data stems from the Mobile Acoustic Communications Experiment (MACE) conducted south of Martha's Vineyard, Mass. The depth at the site is approximately 100 m. A mobile V-fin with an array of transmit projectors attached was towed along a “race track” course approximately 3.8 km long and 600 m wide. The maximum tow speed was 3 kt. (1.5 m/s) and the tow depth varied between 30 and 60 m.

FIG. 11 is a graph of an example MACE10 Transmission Map. The receive hydrophone array was moored at a depth of 50 m. The map is centered around the location of the hydrophone array. The red stars indicate the location of the projector array during the transmissions. The range between the transmit and receive array varied between 2.7 km and 7.2 km. The weather was good throughout the four day experiment. The winds ranged from calm to 10.6 m/s. One projector was used for signal emission and 2 hydrophones were used for reception. The experiment employed a rate 1/2, (131, 171) RSC code and puncturing to obtain an effective code rate of 2/3. Blocks of 19800 bits were generated, interleaved, and mapped to 16-QAM symbols. The carrier frequency was 13 kHz. The receive sampling rate was 39.0625 k samples/second. Data was transmitted at a symbol rate of 9.765625 k symbols/second. Taking into account the 10% overhead from equalizer training, the systems and methods achieves a net data rate of 23.438 kbps. At a distance of 2.7 km the equalizer output BER was below 10⁻⁶ and the overhead from equalizer training was 1%. The net data rate hence increased to about 39 kbps. A raised cosine filter with a roll-off factor 0.2 was used in both the transmitter and the receiver. Two chirps at the beginning of the data transmission and the measurement of their time dilation are used to find initial values for the transmitter velocity.

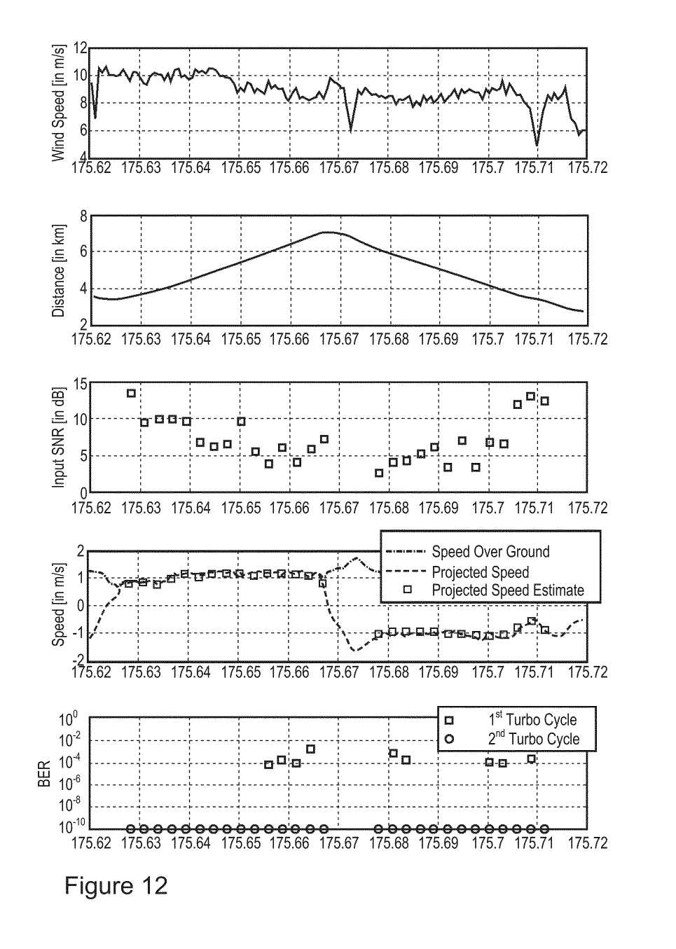

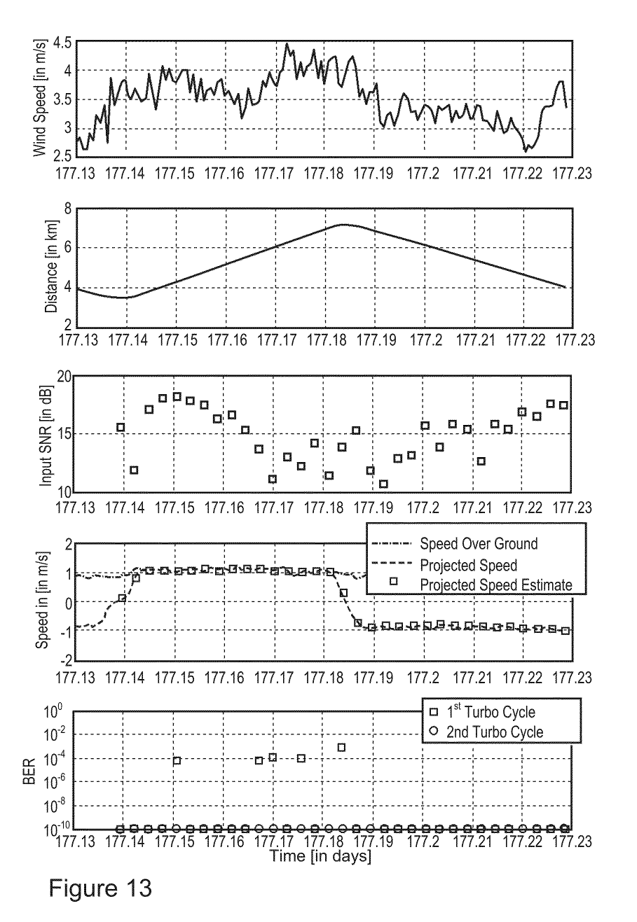

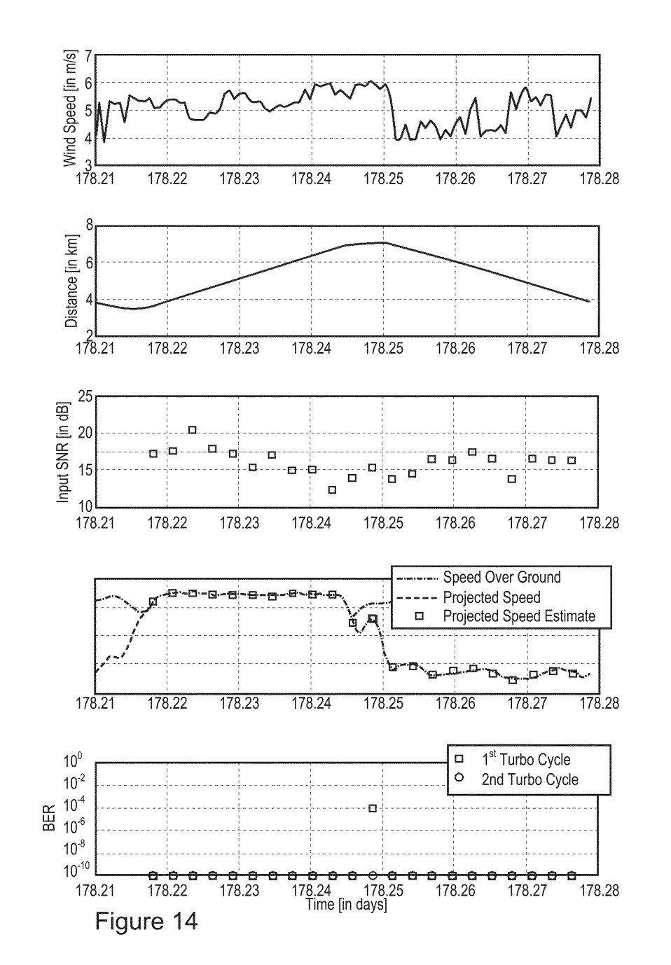

FIGS. 12 (day 1), 13 (day 3) and 14 (day 4) summarize the Bit Error Rate (BER) performance of the receiver of the example MACE 2010 data set. Zero is displayed as 10⁻¹⁰ in the BER plots. For all transmission the receiver converged to the right code word after two or less cycles.

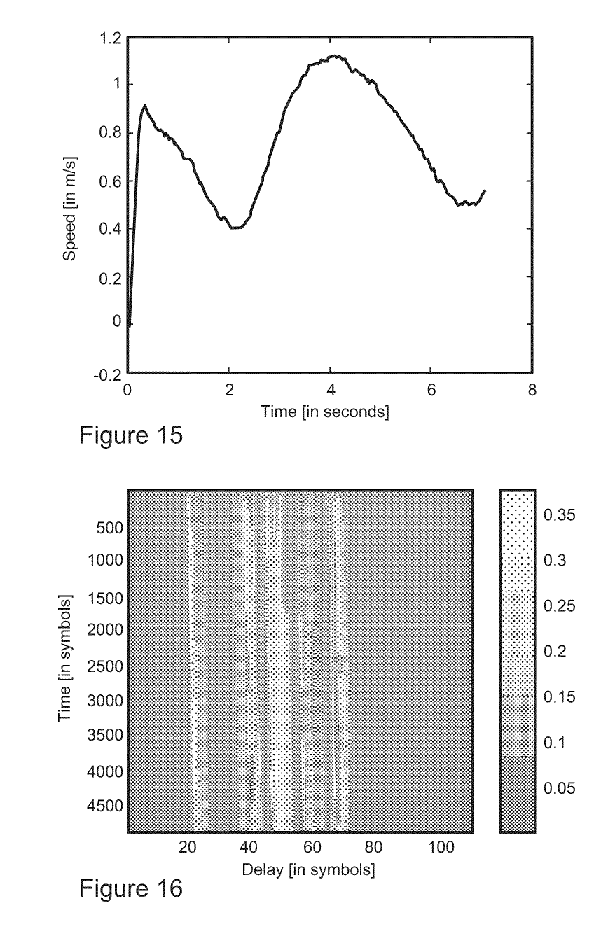

FIG. 15 is a graph of an example speed as estimated by our Doppler compensator during an example MACE10 transmission. FIG. 15 illustrates that the projected speed between transmitter and receiver fluctuated significantly giving rise to highly time-varying Doppler.

FIG. 16 is a graph of an example absolute value of channel impulse response as estimated during an example MACE10 transmission. Due to the shallow water at the experiment site, the channel exhibited severe multi-path as illustrated in FIG. 16.

For interaction and discussions with the subsea oil and gas industry, focus can be on communication over shorter distances while scaling up bandwidth and data rate. In a 1.22 m×1.83 m×49 m wave-tank, an example experiment is conducted with a set of ITC-1089D transducers, which have around 200 kHz of bandwidth at a center frequency of around 300 kHz. The systems and methods can achieve about 1.2 Mbps over a distance of 12 m using this experimental setup. A 64-QAM constellation was employed and the equalizer output BER was about 10⁻³. In a smaller tank, rates reach about 120 Mbps over distances of less than 1 m. For the experiment, high frequency ultrasound transducers were repurposed with a bandwidth of 20 MHz and a center frequency of 20 MHz and again transmitted 64-QAM symbols. The BER at the equalizer output was about 2×10⁻².

TABLE
Performance of different underwater communication methods in past field-tests.

| Team | Data Rate | | Range | | Speed | | Power | | Method |
|---|---|---|---|---|---|---|---|---|---|
| LinkQuest | 80 | bps | 4 | km | >1.5 | m/s | 48 | W | SS |
| MIT/WHOI | 80 | bps | 4 | km | >1.5 | m/s | 50 | W | FH-FSK |
| MIT/WHOI | 2.5 | kbps | 1 | km | <0.05 | m/s | 50 | W | DFE |
| MIT/WHOI | 150 | kbps | 9 | m | 0 | m/s | ~10 | W | DFE |
| TRE method | 23.4 | kbps | >7.2 | km | >1.5 | m/s | 15 | W | TRE |
| TRE method | 39 | kbps | 2.7 | km | >1.5 | m/s | 15 | W | TRE |
| TRE method | 1.2 | Mbps | 12 | m | >1.5 | m/s | 0.33 | W | TRE |
| TRE method | 100 | Mbps | <1 | m | 0 | m/s | 1 | W | TRE |

The Table shows examples to compare performance of the TRE method with competing approaches both from academia and industry. Speed values are maximum values with BER<10⁻⁹. The LinkQuest modem is representative of commercially available acoustic modems. The LinkQuest modem uses some proprietary spread spectrum (SS) method for communication. The WHOI modem uses frequency shift keying (FSK) for its robust 80 bps mode. Both of these methods handle motion but only provide low data rates. For their high data rate experiments, WHOI uses a combination of a phase-locked loop and standard linear decision feedback equalization (DFE). This method yields higher data rates than their FSK method but may require both transmitter and receiver to be near stationary. The at-sea experiments shows that at a carrier frequency of 15 kHz this method tolerates phase variations up to about 2 rad/s which corresponds to a speed of only 0.0318 m/s. The TRE method is robust to all levels of Doppler that was able to simulate in laboratory experiments and at-sea tests so far (>1.5 m/s) and still reliably obtains the highest data rates ever recorded for acoustic underwater communication. The ultrasound equipment used for the 100 Mbps experiment did not allow the transmitter or receiver to move so only the stationary case could be tested.

The systems and methods describe a sample-by-sample, recursive resampling technique, in which time-varying Doppler is modeled, tracked and compensated. Integrated into an iterative turbo equalization based receiver, the Doppler compensation technique can demonstrate unprecedented communication performance. In one example, field data stems from the MACE10 experiment conducted in the waters 100 km south of Martha's Vineyard, Mass. Under challenging conditions (harsh multi-path, ranges up to 7.2 km, SNRs down to 2 dB and relative speeds up to 3 knots) the algorithms sustained error-free communication over the period of three days at a data rate of 39 kbps at 2.7 km distance and a data rate of 23.4 kbps at 7.2 km distance using a 185 dB source. Using a 9.76 kHz of acoustic bandwidth lead to bandwidth efficiencies of 3.99 bps/Hz and 2.40 bps/Hz, respectively. Compared to frequency-shift keying with frequency-hopping (FH-FSK) with a bandwidth efficiency of 0.02 bps/Hz, which is the only existing acoustic communication method robust enough to handle these conditions, this provides an improvement of two orders of magnitude in data rate and bandwidth efficiency.

Other implementations can include applications of interest for the subsea oil and gas industry with a focus on communication over shorter distances while scaling up bandwidth and data rate. In one example, in a 1.22 m×1.83 m×49 m wave-tank, a set of ITC-1089D transducers was used which have around 200 kHz of bandwidth at a center frequency of around 300 kHz. About 1.2 Mbps was achieved over a distance of 12 m using this experimental setup. In a smaller tank, rates of 120 Mbps are reached over distances of less than 1 m. The underwater acoustic channel remains one of the most difficult communication channels.

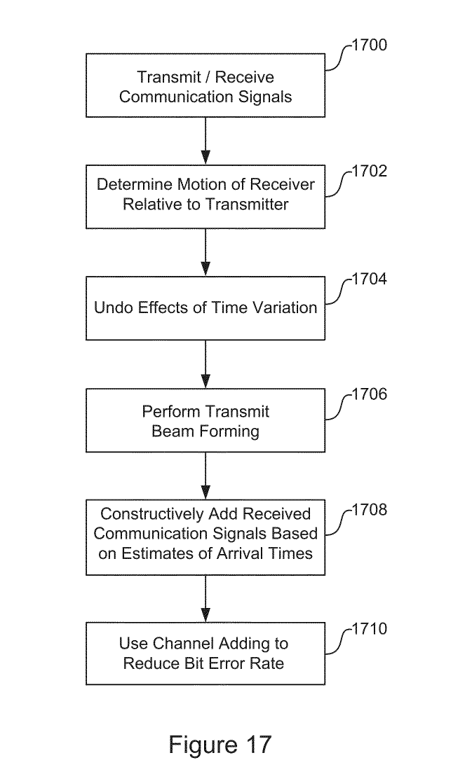

FIG. 17 is a flowchart of an example process for handling Doppler and time dispersion effects, e.g., for underwater wireless communications. A receiver can receive a communication signal from a transmitter (1700). A motion determining unit, e.g., Kalman filter, connected with the receiver can provide information about a motion of the receiver relative to the transmitter (1702). The motion determining unit can dynamically track compression and dilation of the received communication signal to recover the communication waveform. An adaptive equalizer connected with the transmitter can use the information about the motion to undo effects of time variation in the communication signal (1704). The adaptive equalizer can jointly handle both Doppler and time dispersion effects. Additionally or alternatively, the adaptive filter can slice symbols from the communication signal back to a corresponding bit pattern that agrees with a bit sequence that was sent originally. The information about the motion can be bidimensional, e.g., a first dimension including a speed process modeled as a Brownian motion reflected off a symmetric two-sided boundary, and a second dimension including a position process, which is an integral of the first dimension. The transmitter can perform transmit beam-forming based upon a location of the receiver to mitigate multi-path in short range channels (1706). The transmitter can also send the receiver estimates of arrival times of the communication signal so that the receiver can compensate based on the sent arrival times to constructively add received communication signal components (1708). The receiver can use channel coding to reduce bit error rate.

In one embodiment, a system can include a receiver configured to receive a communication signal from a transmitter; a motion determining unit connected with the receiver configured to provide information about a motion of the receiver relative to the transmitter; and an adaptive equalizer connected with the transmitter, the adaptive equalizer configured to use the information about the motion to undo effects of time variation in the communication signal. In one embodiment, the system can include a Kalman filter connected with the receiver, where the Kalman filter estimates the motion between the transmitter and the receiver. In one embodiment, the system can include a motion determining unit configured to dynamically track compression and dilation of the received communication signal. In one embodiment, the system can include an adaptive equalizer configured to jointly handle both Doppler and time dispersion effects. In one embodiment, the system can include the adaptive equalizer configured to slice symbols from the communication signal back to a corresponding bit pattern that agrees with a bit sequence that was sent originally. In one embodiment, the system can include channel coding to reduce bit error rate. In one embodiment, the system can include the transmitter and/or the receiver being located underwater. In another embodiment, the transmitter and/or the receiver can be located at the surface of water. In one embodiment, the communications described herein can be applied to biomedical applications, such as having one of the transmitter or the receiver within the body and the other of the transmitter or the receiver outside of the body.

In one embodiment, a method can include receiving a communication signal from a transmitter; providing information about a motion of the receiver relative to the transmitter; and undoing effects of time variation in the communication signal based on the information about the motion. In one embodiment, the method can include performing transmit beam-forming based upon a location of the receiver to mitigate multi-path in short range channels. As an example, an array of transmit elements, and/or an array of receive elements can be utilized. These arrays could be used for beamforming on the transmitter, beamforming on the receiver, and/or using a vector-based receiver. In one embodiment, the method can include sending the receiver estimates of arrival times of the communication signal. In one embodiment, the method can include dynamically tracking compression and dilation of the received communication signal. In one embodiment, the method can include jointly handling both Doppler and time dispersion effects. In one embodiment, the method can include slicing symbols from the communication signal back to a corresponding bit pattern (or transmitted symbol) that agrees with a bit sequence (or transmitted symbol) that was sent originally. In one embodiment, the method can include channel coding to reduce bit error rate. In another embodiment, equalization and decoding can be performed jointly, such as via turbo equalization.

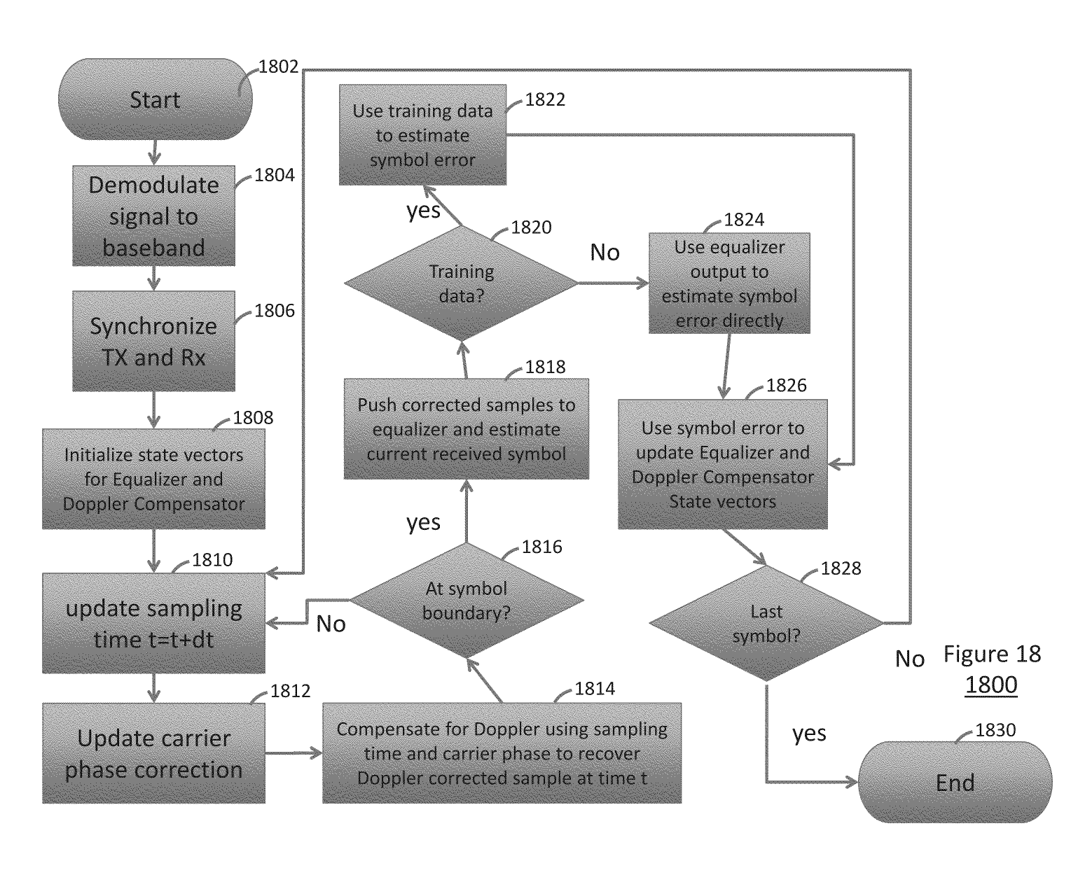

Referring to FIG. 18, a method 1800 is illustrated for communications where the transmitted signal may be different from the received signal based on various effects, such as dispersion, nonlinearity, or noise induced by one or more of the transmitter, the transmission channel, or the receiver. Method 1800 can begin at 1802 and can proceed to 1804 where the signal is demodulated to baseband. At 1806, the transmitted signal and the received signal can be synchronized. In one embodiment, at 1808 state vectors can be initialized such as for equalizer and Doppler compensators.

At 1810, a sampling time can be updated. At 1812, carrier phase correction can be updated. At 1814, the sampling time and carrier phase correction can be used for compensation for Doppler effects in order to recover a Doppler corrected sample. At 1816, if the method is not operating at the symbol boundary then method 1800 can return to 1810 and 1812 for updating the sampling time and updating the carrier phase correction. If on the other hand, the method is operating at the symbol boundary then at 1818 corrected samples can be provided to the equalizer and a current received symbol can be estimated.

At 1820, if there is training data available then at 1822 the training data can be utilized to estimate a symbol error. If on the other hand, there is no training data available then at 1824 the output of the equalizer can be utilized to estimate the symbol error directly. At 1826, the estimated symbol error can be utilized to update the equalizer and Doppler compensator state vectors. At 1828, if this is the last symbol of the communications then method 1800 can end at 1830, otherwise, the method returns to 1810 and 1812 for updating the sampling time and updating the carrier phase correction.

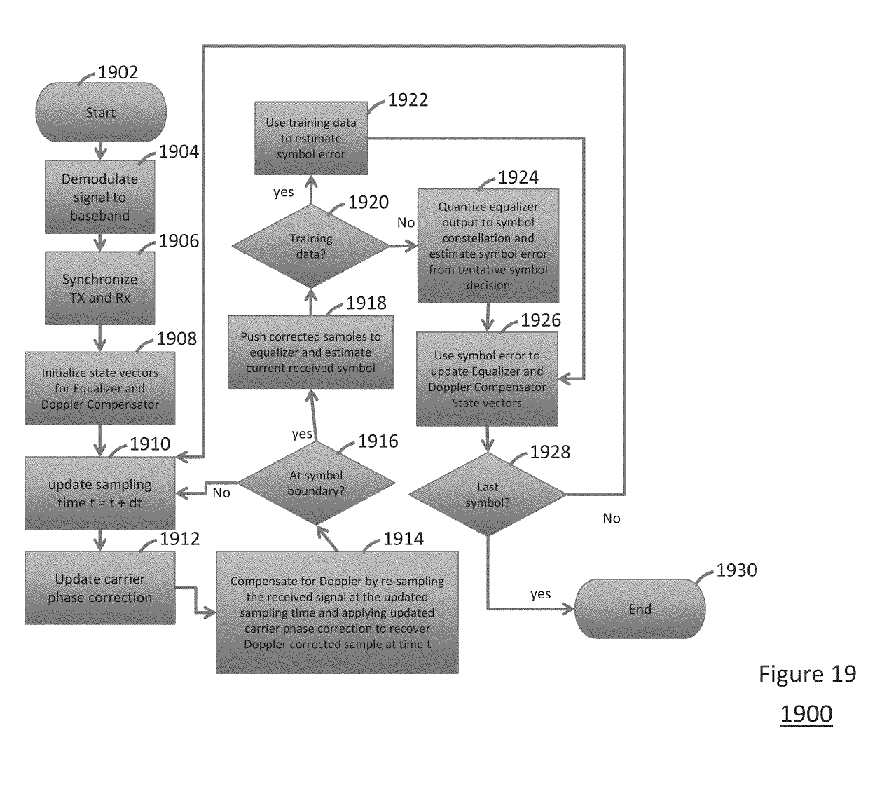

Referring to FIG. 19, a method 1900 is illustrated for communications where the transmitted signal may be different from the received signal based on various effects, such as from one or more of the transmitter, the channel, or the receiver. Method 1900 can begin at 1902 and can proceed to 1904 where the signal is demodulated to baseband. At 1906, the transmitted signal and the received signal can be synchronized. In one embodiment, at 1908 state vectors can be initialized such as for equalizer and Doppler compensators.

At 1910, a sampling time can be updated. At 1912, carrier phase correction can be updated. At 1914, re-sampling the received signal at the updated sampling time and applying updated carrier phase correction can be performed to compensate for Doppler effects to recover a Doppler corrected sample. At 1916, if the method is not operating at the symbol boundary then method 1900 can return to 1910 and 1912 for updating the sampling time and updating the carrier phase correction. If on the other hand, the method is operating at the symbol boundary then at 1918 corrected samples can be provided to the equalizer and a current received symbol can be estimated.

At 1920, if there is training data available then at 1922 the training data can be utilized to estimate a symbol error. If on the other hand, there is no training data available then at 1924 equalizer output can be quantized to a symbol constellation and the symbol error can be estimated from a tentative symbol decision. At 1926, the estimated symbol error can be utilized to update the equalizer and Doppler compensator state vectors. At 1928, if this is the last symbol of the communications then method 1900 can end at 1930, otherwise, the method returns to 1910 and 1912 for updating the sampling time and updating the carrier phase correction.

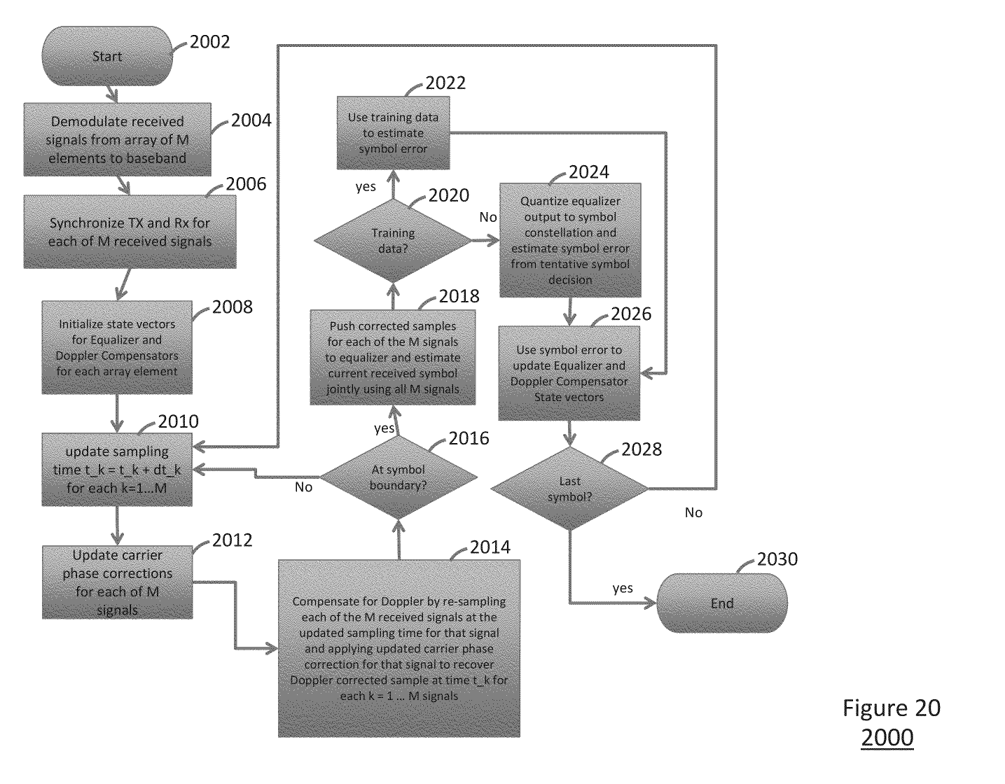

Referring to FIG. 20, a method 2000 is illustrated for communications where the transmitted signal may be different from the received signal based on various effects, such as from one or more of the transmitter, the channel, or the receiver. Method 2000 can begin at 2002 and can proceed to 2004 where signals received from an array of M elements can be demodulated to baseband. At 2006, the transmitted signal and the received signal can be synchronized for each of the M received signals. In one embodiment, at 2008 state vectors can be initialized for each array element for equalizer and Doppler compensators.

At 2010, a sampling time can be updated. At 2012, carrier phase correction can be updated for each of the M received signals. At 2014, re-sampling each of the M received signals at the updated sampling time for that corresponding signal and applying updated carrier phase correction can be performed to compensate for Doppler effects to recover a Doppler corrected sample for each of the M received signals.

At 2016, if the method is not operating at the symbol boundary then method 2000 can return to 2010 and 2012 for updating the sampling time and updating the carrier phase correction. If on the other hand, the method is operating at the symbol boundary then at 2018 corrected samples for each of the M received signals can be provided to the equalizer. A current received symbol can be estimated jointly using all of the M received signals.

At 2020, if there is training data available then at 2022 the training data can be utilized to estimate a symbol error. If on the other hand, there is no training data available then at 2024 equalizer output can be quantized to a symbol constellation and the symbol error can be estimated from a tentative symbol decision. At 2026, the estimated symbol error can be utilized to update the equalizer and Doppler compensator state vectors. At 2028, if this is the last symbol of the communications then method 2000 can end at 2030, otherwise, the method returns to 2010 and 2012 for updating the sampling time and updating the carrier phase correction.

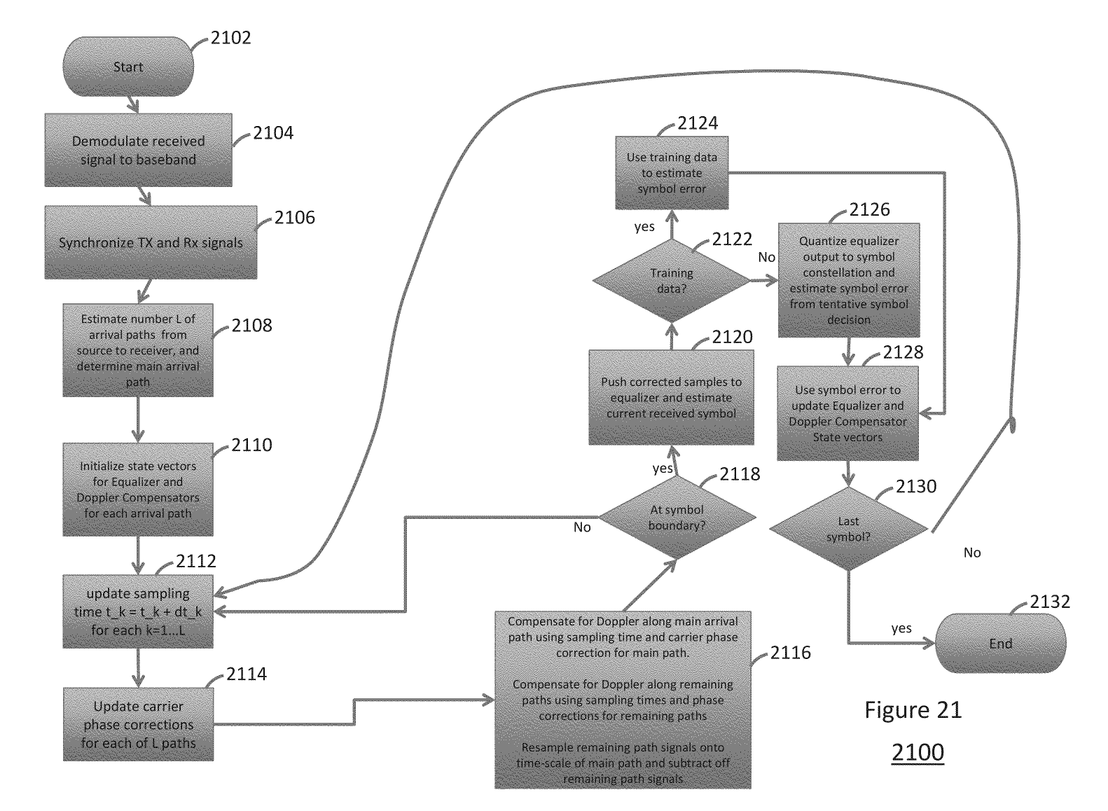

Referring to FIG. 21, a method 2100 is illustrated for communications where the transmitted signal may be different from the received signal based on various effects, such as from one or more of the transmitter, the channel, or the receiver. Method 2100 can begin at 2102 and can proceed to 2104 where a signal can be demodulated to baseband. At 2106, the transmitted signal and the received signal can be synchronized.

At 2108, an estimate can be made of the number L of arrival paths from a source to the receiver. This estimate can include determining a main arrival path. In one embodiment, at 2110 state vectors can be initialized for each arrival path for equalizer and Doppler compensators.

At 2112, a sampling time can be updated for each arrival path. At 2114, carrier phase correction can be updated for each arrival path. At 2116, compensation can be performed for Doppler effects along the main arrival path using the sampling time and the carrier phase correction corresponding to the main arrival path. Compensation can be performed for Doppler effects along the remaining arrival paths using the sampling times and the carrier phase corrections corresponding to each of the remaining arrival paths. Re-sampling can be performed for the remaining path signals onto a time-scale of the main arrival path and then the remaining path signals can be subtracted off.

At 2118, if the method is not operating at the symbol boundary then method 2100 can return to 2112 and 2114 for updating the sampling time and updating the carrier phase correction for each of the arrival paths. If on the other hand, the method is operating at the symbol boundary then at 2120 corrected samples can be provided to the equalizer and a current received symbol can be estimated.

At 2122, if there is training data available then at 2124 the training data can be utilized to estimate a symbol error. If on the other hand, there is no training data available then at 2126 equalizer output can be quantized to a symbol constellation and the symbol error can be estimated from a tentative symbol decision. At 2128, the estimated symbol error can be utilized to update the equalizer and Doppler compensator state vectors. At 2130, if this is the last symbol of the communications then method 2100 can end at 2132, otherwise, the method returns to 2112 and 2114 for updating the sampling time and updating the carrier phase correction for the arrival paths.

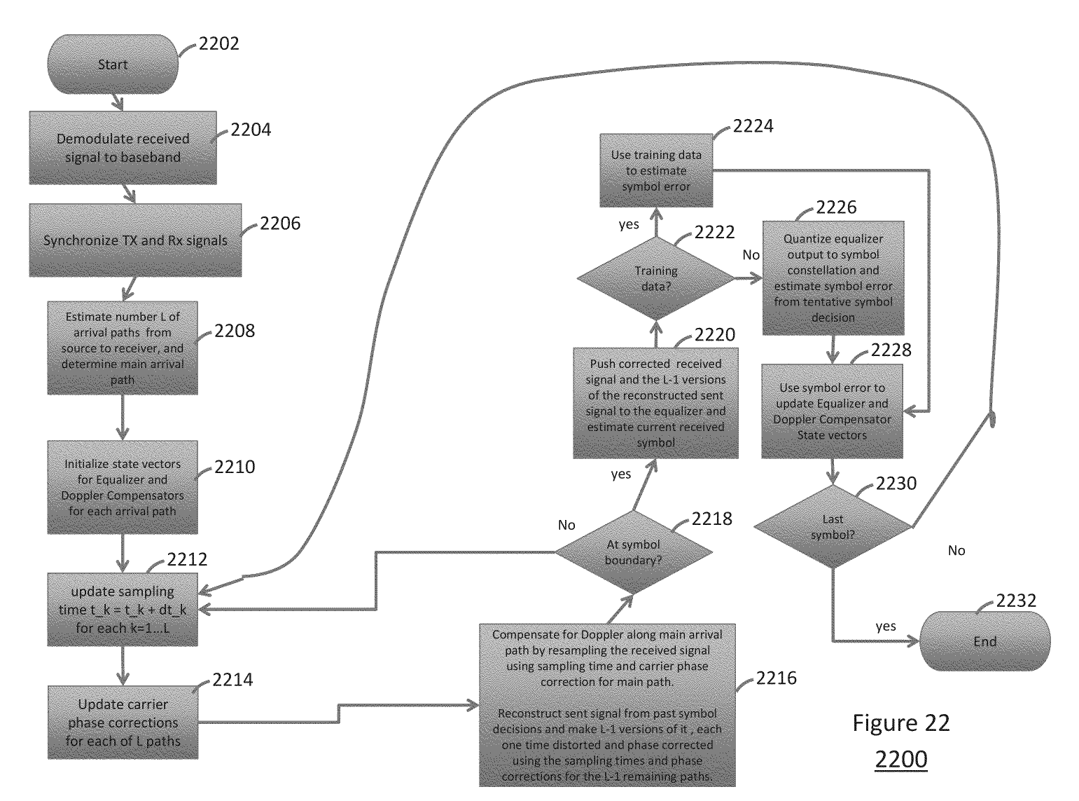

Referring to FIG. 22, a method 2200 is illustrated for communications where the transmitted signal may be different from the received signal based on various effects, such as from one or more of the transmitter, the channel, or the receiver. Method 2200 can begin at 2202 and can proceed to 2204 where a signal can be demodulated to baseband. At 2206, the transmitted signal and the received signal can be synchronized.

At 2208, an estimate can be made of the number L of arrival paths from a source to the receiver. This estimate can include determining a main arrival path. In one embodiment, at 2210 state vectors can be initialized for each arrival path for equalizer and Doppler compensators.

At 2212, a sampling time can be updated for each arrival path. At 2214, carrier phase correction can be updated for each arrival path. At 2216, compensation can be performed for Doppler effects along the main arrival path by resampling the received signal using the sampling time and the carrier phase correction for the main arrival path. The transmitted signal can be reconstructed from past symbol decisions and L−1 versions can be generated, where each version is time distorted and phase corrected using the sampling times and phase corrections for the L−1 remaining paths.

At 2218, if the method is not operating at the symbol boundary then method 2200 can return to 2212 and 2214 for updating the sampling time and updating the carrier phase correction for each of the arrival paths. If on the other hand, the method is operating at the symbol boundary then at 2220 the corrected received signal and the L−1 versions of the reconstructed transmitted signal can be provided to the equalizer and estimate current received symbol can be estimated.

At 2222, if there is training data available then at 2224 the training data can be utilized to estimate a symbol error. If on the other hand, there is no training data available then at 2226 equalizer output can be quantized to a symbol constellation and the symbol error can be estimated from a tentative symbol decision. At 2228, the estimated symbol error can be utilized to update the equalizer and Doppler compensator state vectors. At 2230, if this is the last symbol of the communications then method 2200 can end at 2232, otherwise, the method returns to 2212 and 2214 for updating the sampling time and updating the carrier phase correction for the arrival paths.

The systems and methods described above may be implemented in many different ways in many different combinations of hardware, software firmware, or any combination thereof. In one example, the systems and methods can be implemented with a processor and a memory, where the memory stores instructions, which when executed by the processor, causes the processor to perform the systems and methods. The processor may mean any type of circuit such as, but not limited to, a microprocessor, a microcontroller, a graphics processor, a digital signal processor, a graphics processing unit, a central processing unit, or another processor, etc. The processor may also be implemented with discrete logic or components, or a combination of other types of analog or digital circuitry, combined on a single integrated circuit or distributed among multiple integrated circuits. All or part of the logic described above may be implemented as instructions for execution by the processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. A product, such as a computer program product, may include a storage medium and computer readable instructions stored on the medium, which when executed in an endpoint, computer system, or other device, cause the device to perform operations according to any of the description above. The memory can be implemented with one or more hard drives, and/or one or more drives that handle removable media, such as diskettes, compact disks (CDs), digital video disks (DVDs), flash memory keys, and other removable media.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

Many modifications and other embodiments set forth herein can come to mind to one skilled in the art having the benefit of the teachings presented in the foregoing descriptions and the associated drawings. Although specified terms are employed herein, they are used in a generic and descriptive sense only and not for purposes of limitation.

Dedicated hardware implementations including, but not limited to, application specific integrated circuits, programmable logic arrays and other hardware devices can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable gate array. Furthermore, software implementations (e.g., software programs, instructions, etc.) including, but not limited to, distributed processing or component/object distributed processing, parallel processing, or virtual machine processing can also be constructed to implement the methods described herein. It is further noted that a computing device such as a processor, a controller, a state machine or other suitable device for executing instructions to perform operations or methods may perform such operations directly or indirectly by way of one or more intermediate devices directed by the computing device.

Tangible computer-readable storage mediums are an example embodiment that includes a single medium or multiple media (e.g., a centralized or distributed database, and/or associated caches and servers) that store the one or more sets of instructions for performing all or some of the steps described herein (and may perform other steps as well). The term “tangible computer-readable storage medium” shall also be taken to include any non-transitory medium that is capable of storing or encoding a set of instructions for execution by the machine and that cause the machine to perform any one or more of the methods of the subject disclosure. The term “non-transitory” as in a non-transitory computer-readable storage includes without limitation memories, drives, devices and anything tangible but not a signal per se.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. The exemplary embodiments can include combinations of features and/or steps from multiple embodiments. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order or function unless expressly stated so. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

In one or more embodiments, a processor (which can include a controller or circuit) has been described that performs various functions. It should be understood that the processor can be multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, application specific integrated circuit, and/or programmable gate array including a Field PGA. In one or more embodiments, when a processor executes instructions to perform “operations”, this can include the processor performing the operations directly and/or facilitating, directing, or cooperating with another device or component to perform the operations.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A system comprising:
a receiver configured to receive a communication signal from a transmitter that transmits the communication signal along a first reference time axis signal, the receiver receiving the transmitted communication signal along a second reference time axis; and
a time-distortion estimation unit communicatively coupled with the receiver and configured to provide information about a relationship between the first reference time axis and a second reference time axis of the received communication signal.

2. The system of claim 1, wherein the second reference time axis comprises one or more of delay, time dilation, time compression, or any combination thereof.

3. The system of claim 1, wherein the received communication signal is distorted due to effects of one or more of dispersion or noise from one or more of a channel, the transmitter or the receiver.

4. The system of claim 1, wherein the transmitter transmits the communication signal as a sequence of transmit pulse shapes at uniformly spaced intervals of time along the first reference time axis and the receiver receives a sequence of receive pulse shapes at non-uniformly spaced intervals of time along the second reference time axis, wherein the receive pulse shapes are different from the transmit pulse shapes based on effects of one or more of the transmitter, a channel, or the receiver.

5. The system of claim 1, wherein the communication signal is transmitted by the transmitter according to one of pulse amplitude modulation, quadrature amplitude modulation, orthogonal frequency division multiplexing, phase shift keying, minimum shift keying, pulse position modulation, trellis coded modulation, modulation to a carrier frequency, or any combination thereof.

6. The system of claim 1, wherein the information comprises an adjustment to the second reference time axis to generate a compensated second time axis such that the compensated second time axis approximates the first reference time axis.

7. The system of claim 1, wherein the transmitted communication signal comprises a sequence of information symbols, the information symbols being used to modulate a sequence of transmitted pulse shapes, or to adjust an amplitude and phase of a carrier in the transmitted communication signal, or a combination thereof.

8. The system of claim 7, wherein the receiver comprises a receive processor that estimates the transmitted sequence of information symbols, wherein the sequence of transmitted pulse shapes are modulated by an information sequence and a resulting communication signal is modulated to a carrier frequency.

9. The system of claim 1, wherein the receiver comprises a receive processor that processes the received communication signal to estimate the transmitted communication signal.

10. The system of claim 9, wherein the receive processor comprises one or more of an equalization unit, a decoding unit, and the time-distortion estimation unit.

11. The system of claim 10, wherein the receive processor performs operations comprising time-distortion estimation and compensation, equalization by the equalization unit, and decoding by the decoding unit.

12. The system of claim 11, wherein the receive processor repeats the operations on a sample-by-sample basis for every sample of the received communication signal, wherein a sampling rate is equal to or faster than an information symbol rate.

13. The system of claim 11, wherein the receive processor operates on a symbol-by-symbol basis.

14. The system of claim 13, wherein the receive processor performs operations comprising at least one of time-distortion estimation and compensation, equalization, and decoding, wherein the operations are repeated for each transmitted information symbol.

15. The system of claim 14, wherein the receive processor repeats the operations multiple times for each transmitted information symbol.

16. The system of claim 1, wherein the time-distortion estimation unit enables the receiver to interpolate the received communication signal to approximate the first reference time axis.

17. The system of claim 1, wherein the transmitter estimates a time-distortion and pre-distorts the first reference time axis to create a third time-axis.

18. The system of claim 1, wherein the received communication signal comprises multi-path effects including multiple superimposed receive communication signals, and wherein the time-distortion estimation unit provides the information based in part on the multi-path effects.

19. The system of claim 18, wherein the time-distortion estimation unit compensates each path of the multi-path effects with a corresponding compensation.

20. The system of claim 18, wherein the time-distortion estimation unit compensates each path according to time axes for each of the multiple superimposed receive communication signals.

21. The system of claim 18, wherein the time-distortion estimation unit comprises a group of time-distortion estimation units, wherein each unit of the group compensates a corresponding path of the multi-path effects with a corresponding compensation.

22. The system of claim 1, wherein the received communication signal is a group of signals that are sampled uniformly in time according to the second reference time axis.

23. A method comprising:
receiving, by a system that includes a time-distortion estimation unit having a processor, a received waveform from a receiver, wherein the receiver receives a communication signal from a transmitter according to the transmitter transmitting a transmit waveform associated with a first time axis and the receiver receiving a receive waveform associated with a second time axis, wherein the transmit and receive waveforms are different based on effects of one or more of the transmitter, a channel, or the receiver; and
generating, by the system, a compensated second time axis by adjusting the second time axis to approximate the first time axis.

24. The method of claim 23, wherein the receive waveform is a group of waveforms that are sampled uniformly in time according to the second time axis.

25. The method of claim 23, wherein the receive waveform is a group of waveforms that are sampled non-uniformly in time and that arrive at an array of receiver elements.

26. A system comprising:
a transmitter configured to transmit a communication signal;
a receiver configured to receive the communication signal from the transmitter, wherein the transmitter transmits the communication signal along a first time axis and the receiver receives the communication signal along a second time axis; and
a time distortion estimation unit for estimating a relationship between the first time axis and the second time axis.

27. The system of claim 26, wherein the communication signal comprises a video signal, a sonar signal, or a combination thereof.

28. The system of claim 26, wherein the communication signal comprises real-time control signals for a remote vehicle.

29. The system of claim 26, wherein the system is configured for two way communication, wherein the transmitter is a control transmitter and the communication signal comprises a control signal for a remote vehicle, and wherein the remote vehicle comprises a second transmitter for sending video content, sonar content, or a combination thereof.

30. The system of claim 26, wherein the time distortion estimation unit is configured to adjust the second time axis to generate a compensated second time axis that approximates the first time axis.

31. The system of claim 26, further comprising a Kalman filter connected with the receiver, the Kalman filter estimating relative motion between the transmitter and the receiver.

32. The system of claim 26, wherein compression and dilation of the received communication signal is dynamically tracked.

33. The system of claim 26, further comprising an adaptive equalizer configured to jointly handle both Doppler and time dispersion effects.

34. The system of claim 26, wherein the transmitter uses acoustic waves for transmission.

35. The system of claim 26, wherein the transmitter and receiver are underwater.

36. The system of claim 26, wherein the transmitter performs transmit beam-forming based upon a location of the receiver to mitigate multi-path in short range channels.

37. The system of claim 26, wherein one of the transmitter, the receiver or both include an array of elements to perform one of beam-forming, spatial multiplexing, spatial demultiplexing, spatial filtering, or any combination thereof.

38. The system of claim 26, wherein motion estimation is used to determine a position of at least one of the receiver or the transmitter.

39. The system of claim 38, wherein inputs are received from a tracking or inertial navigation system (INS) in at least one of the transmitter or the receiver.
